(19) United States
(12) Patent Application Publication
(10) Pub. No.: US 2026/0252786 A1
(43) Pub. Date: Aug. 27, 2026

(54) SYSTEM

(71) Applicant: SoftBank Group Corp., Tokyo (JP)

(72) Inventor: Masanori TADA, Tokyo (JP)

(73) Assignee: SoftBank Group Corp., Tokyo (JP)

(21) Appl. No.: 19/533,288

(22) Filed: Feb. 9, 2026

(30) Foreign Application Priority Data
Feb. 21, 2025 (JP) 2025-027077

(51) Int. Cl. G06F 40/109; G06F 3/01; G06F 3/04845; G10L 15/26; G10L 21/0208; G10L 25/30; G10L 25/60; G10L 25/63; G10L 25/90

(52) U.S. Cl. CPC G06F 40/109; G06F 3/013; G06F 3/04845; G10L 15/26; G10L 21/0208; G10L 25/30; G10L 25/60; G10L 25/63; G10L 25/90

(57) ABSTRACT

The system according to the embodiment comprises a voice analysis unit, a record reference unit, a display unit, and a speech display unit. The voice analysis unit analyzes the tone of the distributor's voice. The record reference unit determines a font or style of a telop based on the tone analyzed by the voice analysis unit. The display unit displays the telop based on the font or style determined by the record reference unit. The speech display unit analyzes a user's utterance in real time and displays it in a speech balloon format.

### CROSS-REFERENCE TO RELATED APPLICATION

The present application claims priority to and incorporates by reference the entire contents of Japanese Patent Application No. 2025-027077 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, in real-time distribution, there has been a problem that it is not possible to automatically change the font or style of a telop according to the tone of the distributor's voice, resulting in limited effectiveness of information transmission to viewers.

### SUMMARY OF THE INVENTION

The system according to the embodiment comprises a voice analysis unit, a record reference unit, a display unit, and a speech display unit. The voice analysis unit analyzes the tone of the distributor's voice. The record reference unit determines a font or style of a telop based on the tone analyzed by the voice analysis unit. The display unit displays the telop based on the font or style determined by the record reference unit. The speech display unit analyzes a user's utterance in real time and displays it in a speech balloon format.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

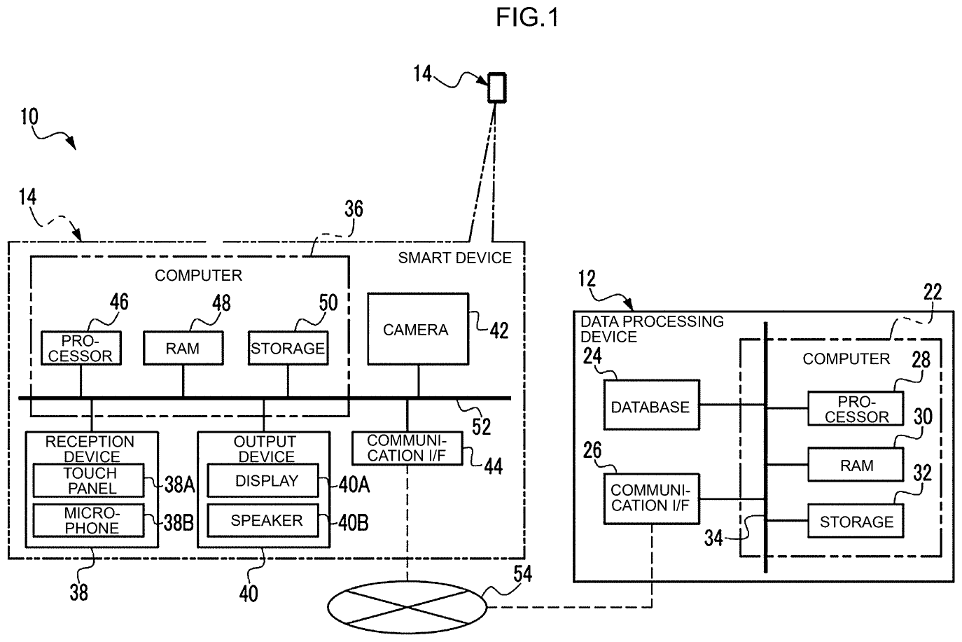

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

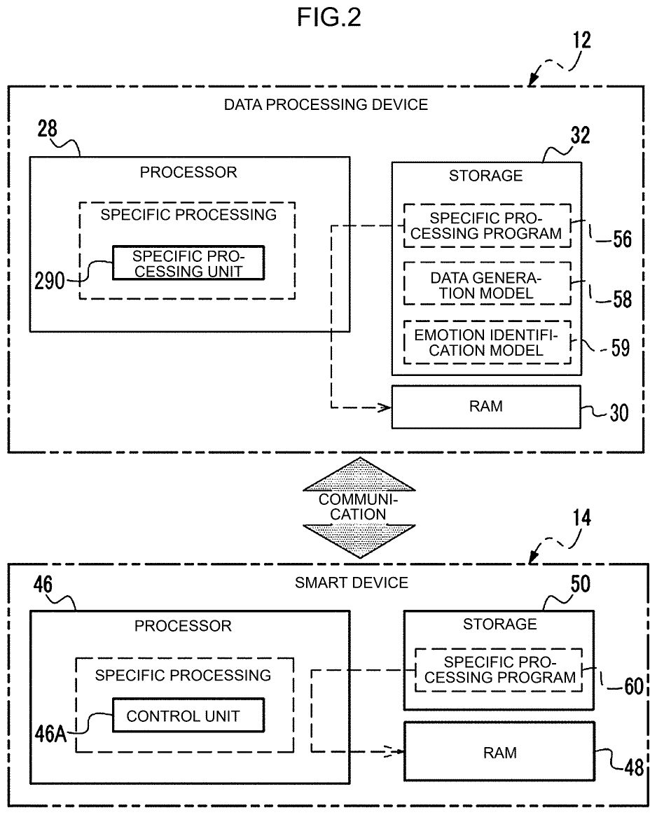

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The real-time distribution system according to the embodiment of the present invention is a system that creates telops with font processing in real time based on the tone of the distributor's voice and past distribution records. This system analyzes the tone of the distributor's voice and determines the font or style of the telop based on the analysis result. In addition, it refers to past distribution records and determines the font or style of the telop based on the content or style of the distributor's utterance. Furthermore, it provides a mechanism in a VR space in which a user's utterance is displayed in a format similar to a comic speech balloon. For example, when the distributor is excited, the telop is displayed in bold or large font. If a particular phrase has been frequently used in the past, a specific font style is applied to that phrase. When a user utters “Hello,” the utterance is displayed in the form of a speech balloon. This system enables visually attractive telops to be provided in real-time distribution and also visually displays user utterances in the VR space. As a result, the real-time distribution system can create telops in real time based on the tone of the distributor's voice and past distribution records, and display utterances in the VR space in a comic speech balloon format. Specifically, the real-time distribution system is composed of multiple hardware and software modules, such as a voice analysis unit, a record reference unit, a display unit, and a speech display unit. The voice analysis unit acquires the distributor's audio signal from a microphone or the like and inputs it as PCM data with a sampling rate of 16 kHz or higher. The input data undergoes preprocessing such as short-time Fourier transform (STFT) and Mel-frequency cepstral coefficient (MFCC) extraction, and is numerically represented as feature vectors (e.g., 128 dimensions) such as tone of the voice (e.g., average frequency, formant distribution), pitch (fundamental frequency F0), and intensity (RMS energy). These features are input into speech emotion recognition models such as convolutional neural networks (CNN) and bidirectional long short-term memory networks (BiLSTM), and the output includes emotion labels such as “excited,” “calm,” and “nervous” (e.g., one-hot vectors), as well as emotion intensity scores (e.g., real values from 0.0 to 1.0). For example, when the input is a voice with “high pitch, loud volume, and fast speaking rate,” the output is an “excited” label and an intensity score of 0.85. Conversely, for “low pitch, low volume, and slow speaking rate,” the output is a “calm” label and an intensity score of 0.25. The record reference unit acquires past distribution records (e.g., audio transcripts of video files, text chat logs, metadata) from a database and performs frequency analysis of utterance content, key phrase extraction, and style clustering using natural language processing models (e.g., Transformer-based contextual embedding models). For example, if the phrase “Thank you for your hard work” appears 50 times in the past, a rule is applied to assign a specific font (e.g., handwritten style) or color (e.g., blue) to that phrase. The display unit receives these analysis results and determines the telop's font (e.g., Gothic, Mincho), size (e.g., 24 pt, 36 pt), color (e.g., red, blue, green), and decoration (e.g., bold, italic, underline) in real time, rendering them on a 2D/3D graphics engine using a GPU. The speech display unit acquires the user's utterance audio or text input in real time, analyzes the utterance content using a speech recognition model (e.g., CTC-based speech-to-text conversion) and a natural language understanding model, and arranges it as a 3D object in the VR space in the form of a comic speech balloon or chat bubble. For example, when a user utters “Hello,” the speech recognition result “Hello” is mapped as a texture onto a speech balloon-shaped polygon and displayed near the user's avatar. Furthermore, when the utterance content is a long sentence, a rectangular shape is used; for short sentences, a circular shape; and for questions, an angular shape, with the shape and size of the speech balloon automatically adjusted according to the content. These series of processes, unlike conventional manual editing or simple rule-based processing by humans, involve dynamic judgment and optimization by machine learning models in high-dimensional feature space, resulting in essential improvements in computer technology such as faster processing speed, improved telop generation accuracy, and the coexistence of visual consistency and diversity. As a technical effect, telop generation reflecting the distributor's emotion and past distribution trends enhances viewer immersion and comprehension, and dramatically improves the communication experience in VR space. Specific application fields include live streaming distribution, virtual events, e-sports commentary, remote education, virtual conferences, and other diverse use cases requiring real-time and visual interaction.

The real-time distribution system according to the embodiment comprises a voice analysis unit, a record reference unit, a display unit, and a speech display unit. The voice analysis unit analyzes the tone of the distributor's voice. The tone of the distributor's voice may include, for example, the tone, pitch, and intensity of the voice, but is not limited thereto. The voice analysis unit, for example, analyzes the tone of the distributor's voice and displays the telop in bold or large font when the distributor is excited. The voice analysis unit may also analyze the pitch of the distributor's voice and display the telop in a standard font when the distributor is calm. The record reference unit analyzes past distribution records and determines the font or style of the telop based on the content or style of the distributor's utterance. Past distribution records may include, for example, recorded data and text logs, but are not limited thereto. The record reference unit, for example, applies a specific font style to a phrase that has been frequently used in the past. The record reference unit may also analyze the content of the distributor's utterance from past distribution records and determine the style of the telop based on the content. The display unit displays the telop based on the font or style determined by the record reference unit. The display unit, for example, displays the telop using the font determined by the record reference unit. The display unit may also display the telop based on the style determined by the record reference unit. The speech display unit analyzes a user's utterance in real time and displays the content of the utterance in a format similar to a comic speech balloon. For example, when a user utters “Hello,” the speech display unit displays the utterance in the form of a speech balloon. The speech display unit may also change the shape or size of the speech balloon according to the content of the user's utterance. Thus, the real-time distribution system according to the embodiment can create telops in real time based on the tone of the distributor's voice and past distribution records, and display utterances in the VR space in a comic speech balloon format. Specifically, the real-time distribution system is composed of multiple hardware and software modules, such as a voice analysis unit, a record reference unit, a display unit, and a speech display unit. The voice analysis unit acquires the distributor's audio signal from a microphone or the like and inputs it as PCM data with a sampling rate of 16 kHz or higher. The voice analysis unit performs preprocessing such as short-time Fourier transform (STFT) and Mel-frequency cepstral coefficient (MFCC) extraction on the input audio data, and generates feature vectors (e.g., 128 dimensions) such as tone of the voice (e.g., average frequency, formant distribution), pitch (fundamental frequency F0), and intensity (RMS energy). The voice analysis unit inputs these feature vectors into speech emotion recognition models such as convolutional neural networks (CNN) and bidirectional long short-term memory networks (BiLSTM), and obtains emotion labels such as “excited,” “calm,” and “nervous” (e.g., one-hot vectors), as well as emotion intensity scores (e.g., real values from 0.0 to 1.0). For example, when the input is a voice with “high pitch, loud volume, and fast speaking rate,” the output is an “excited” label and an intensity score of 0.85. Conversely, for “low pitch, low volume, and slow speaking rate,” the output is a “calm” label and an intensity score of 0.25. The record reference unit acquires past distribution records (e.g., audio transcripts of video files, text chat logs, metadata) from a database and performs frequency analysis of utterance content, key phrase extraction, and style clustering using natural language processing models (e.g., Transformer-based contextual embedding models). For example, if the phrase “Thank you for your hard work” appears 50 times in the past, a rule is applied to assign a specific font (e.g., handwritten style) or color (e.g., blue) to that phrase. The display unit receives these analysis results and determines the telop's font (e.g., Gothic, Mincho), size (e.g., 24 pt, 36 pt), color (e.g., red, blue, green), and decoration (e.g., bold, italic, underline) in real time, rendering them on a 2D/3D graphics engine using a GPU. The speech display unit acquires the user's utterance audio or text input in real time, analyzes the utterance content using a speech recognition model (e.g., CTC-based speech-to-text conversion) and a natural language understanding model, and arranges it as a 3D object in the VR space in the form of a comic speech balloon or chat bubble. For example, when a user utters “Hello,” the speech recognition result “Hello” is mapped as a texture onto a speech balloon-shaped polygon and displayed near the user's avatar. Furthermore, when the utterance content is a long sentence, a rectangular shape is used; for short sentences, a circular shape; and for questions, an angular shape, with the shape and size of the speech balloon automatically adjusted according to the content. These series of processes, unlike conventional manual editing or simple rule-based processing by humans, involve dynamic judgment and optimization by machine learning models in high-dimensional feature space, resulting in essential improvements in computer technology such as faster processing speed, improved telop generation accuracy, and the coexistence of visual consistency and diversity. As a technical effect, this system enables telop generation reflecting the distributor's emotion and past distribution trends, thereby enhancing viewer immersion and comprehension, and dramatically improving the communication experience in VR space. Specific application fields include live streaming distribution, virtual events, e-sports commentary, remote education, virtual conferences, and other diverse use cases requiring real-time and visual interaction.

The voice analysis unit can analyze the tone of the distributor's voice in real time. The specific time range and processing speed for real time may include, for example, within several milliseconds or in seconds, but are not limited thereto. The voice analysis unit, for example, analyzes the tone of the distributor's voice in real time and displays the telop in bold or large font when the distributor is excited. The voice analysis unit may also analyze the pitch of the distributor's voice in real time and display the telop in a standard font when the distributor is calm. By analyzing the tone of the distributor's voice in real time, the font and style of the telop can be determined instantly. Specifically, the voice analysis unit acquires the distributor's audio signal from a microphone at a sampling rate of 16 kHz or higher and inputs it as PCM format audio data. The voice analysis unit performs preprocessing such as short-time Fourier transform (STFT) and Mel-frequency cepstral coefficient (MFCC) extraction on the input audio data, and generates feature vectors (e.g., 128 dimensions) such as tone of the voice (average frequency, formant distribution), pitch (fundamental frequency F0), and intensity (RMS energy). The voice analysis unit inputs these feature vectors into speech emotion recognition models such as convolutional neural networks (CNN) and bidirectional long short-term memory networks (BiLSTM), and obtains emotion labels such as “excited,” “calm,” and “nervous” (one-hot vectors) and emotion intensity scores (real values from 0.0 to 1.0). For example, when the input is a voice with “high pitch, loud volume, and fast speaking rate,” the output is an “excited” label and an intensity score of 0.85. Conversely, for “low pitch, low volume, and slow speaking rate,” the output is a “calm” label and an intensity score of 0.25. The voice analysis unit instantly determines the font and style of the telop (e.g., bold, large font, standard font) based on these output results and instructs the display unit. As a result, the system achieves rapid emotion estimation and telop generation in milliseconds without human manual judgment, thereby realizing both real-time performance and visual consistency, which is an essential improvement in computer technology. As a technical effect, the distributor's emotional changes can be instantly reflected in visual expressions, thereby enhancing viewer immersion and comprehension of the distribution content. Specific application fields include live distribution, virtual events, e-sports commentary, and remote education.

The record reference unit can analyze past distribution records and determine the font or style of the telop based on the content or style of the distributor's utterance. Past distribution records may include, for example, recorded data and text logs, but are not limited thereto. The record reference unit, for example, applies a specific font style to a phrase that has been frequently used in the past. The record reference unit may also analyze the content of the distributor's utterance from past distribution records and determine the style of the telop based on the content. By analyzing past distribution records, telops can be displayed according to the content or style of the distributor's utterance. Specifically, the record reference unit acquires video file audio transcripts, text chat logs, distribution metadata, and other past distribution records from a database. The record reference unit uses natural language processing models (e.g., Transformer-based contextual embedding models) to perform frequency analysis of utterance content, key phrase extraction, and style clustering. For example, if the phrase “Thank you for your hard work” appears 50 times in the past, a rule is applied to assign a specific font (e.g., handwritten style) or color (e.g., blue) to that phrase. The record reference unit determines the telop's font (e.g., Gothic, Mincho), size, color, and decoration (bold, italic, underline) for the extracted key phrases and frequent words, and instructs the display unit. For example, frequently used phrases are assigned emphasis colors or large fonts, while rare phrases are assigned standard styles. These processes, unlike simple rule-based methods, involve dynamic optimization in high-dimensional feature space by machine learning models, thereby providing technical effects different from conventional human work or manual editing. As a technical effect, telop generation that automatically reflects the distributor's past utterance trends and styles is possible, thereby enhancing viewer comprehension and immersion. Specific application fields include live distribution, virtual events, e-sports commentary, and remote education.

The display unit can display the telop based on the font or style determined by the record reference unit. The font and style of the telop may include, for example, font type, size, color, and decoration, but are not limited thereto. The display unit, for example, displays the telop using the font determined by the record reference unit. The display unit may also display the telop based on the style determined by the record reference unit. By displaying the telop based on the font or style determined by the record reference unit, visually attractive telops can be provided. Specifically, the display unit receives font information (e.g., Gothic, Mincho), size (e.g., 24 pt, 36 pt), color (e.g., red, blue, green), and decoration (e.g., bold, italic, underline) parameters from the record reference unit and renders the telop in real time on a 2D/3D graphics engine using a GPU. The display unit also dynamically controls the display position, display order, and stacking order of telops to ensure visibility even when multiple telops are displayed simultaneously. For example, important utterances can be displayed prominently in the center, while supplementary utterances can be displayed smaller at the edge of the screen. The display unit also automatically applies scaling and anti-aliasing processing to telops according to the user's device resolution and screen size. These processes enable real-time and dynamic telop generation and display, unlike conventional static telop display, thereby realizing improvements in computer technology that achieve both visual consistency and diversity. As a technical effect, viewer attention can be effectively guided, and comprehension and immersion in the distribution content can be enhanced. Specific application fields include live distribution, virtual events, e-sports commentary, and remote education.

The speech display unit can analyze a user's utterance in real time and display the content of the utterance in a speech balloon format. The specific time range and processing speed for real time may include, for example, within several milliseconds or in seconds, but are not limited thereto. The speech balloon format may include, for example, comic speech balloons and chat bubbles, but is not limited thereto. The speech display unit, for example, displays the utterance in the form of a speech balloon when a user utters “Hello.” The speech display unit may also change the shape or size of the speech balloon according to the content of the user's utterance. By displaying the user's utterance in a comic speech balloon format, utterances in the VR space become visually attractive. Specifically, the speech display unit acquires the user's utterance audio from a microphone and inputs it as PCM data with a sampling rate of 16 kHz or higher. The speech display unit uses a speech recognition model (e.g., CTC-based speech-to-text conversion) to convert the utterance content into text and analyzes the context and emotion of the utterance using a natural language understanding model. For example, when the input is the audio “Hello,” the output is the text “Hello” with an emotion label “neutral.” The speech display unit determines the shape (e.g., rectangle, circle, angular shape), size (automatically adjusted according to the number of characters or utterance length), and color (bright or dark color according to emotion) of the speech balloon based on the analysis result, and arranges it as a 3D object near the user's avatar in the VR space. For example, long utterances are assigned a rectangular shape, short utterances a circular shape, and questions an angular shape. These processes, unlike conventional manual editing or simple rule-based processing, involve dynamic optimization in high-dimensional feature space by machine learning models, thereby realizing improvements in computer technology that achieve both real-time performance and visual diversity. As a technical effect, immediate visualization of user utterances enhances the communication experience in the VR space and increases viewer immersion and comprehension of utterance content. Specific application fields include virtual events, e-sports commentary, remote education, and virtual conferences.

The voice analysis unit can estimate the distributor's emotion and adjust the accuracy of voice analysis based on the estimated emotion. Specific types of emotions and estimation methods may include, for example, emotion classification such as joy, sadness, and anger, and voice analysis algorithms, but are not limited thereto. The voice analysis unit, for example, estimates emotion using an emotion engine when the distributor is excited and applies specific filtering to improve analysis accuracy. When the distributor is calm, the voice analysis unit estimates emotion using the emotion engine and minimizes noise reduction to maintain analysis accuracy. Furthermore, when the distributor is nervous, the voice analysis unit estimates emotion using the emotion engine and emphasizes specific frequency bands to improve analysis accuracy. By adjusting the accuracy of voice analysis based on the distributor's emotion, more accurate analysis results can be obtained. Specifically, the voice analysis unit acquires the distributor's audio signal from a microphone at a sampling rate of 16 kHz or higher and inputs it as PCM format audio data. The voice analysis unit performs preprocessing such as short-time Fourier transform (STFT) and Mel-frequency cepstral coefficient (MFCC) extraction on the input audio data, and generates multidimensional feature vectors (e.g., 128 to 256 dimensions) such as tone of the voice (average frequency, formant distribution), pitch (fundamental frequency F0), intensity (RMS energy), spectral envelope, and zero-crossing rate. The voice analysis unit inputs these feature vectors into speech emotion recognition models such as convolutional neural networks (CNN), bidirectional long short-term memory networks (BiLSTM), or Transformer-based models, and obtains emotion labels such as “joy,” “sadness,” “anger,” “excited,” “calm,” and “nervous” (one-hot vectors or probability distributions), as well as emotion intensity scores (real values from 0.0 to 1.0). For example, when the input is a voice with “high pitch, loud volume, and fast speaking rate,” the output is an “excited” label and an intensity score of 0.85. Conversely, for “low pitch, low volume, and slow speaking rate,” the output is a “calm” label and an intensity score of 0.25. The voice analysis unit dynamically changes the parameters of filtering and noise reduction processing in the analysis pipeline according to the estimated emotion label and intensity score. For example, in the “excited” state, high-frequency components are emphasized and aggressive noise suppression is applied; in the “calm” state, low-frequency components are retained and the noise reduction threshold is relaxed; and in the “nervous” state, equalization processing is added to emphasize specific frequency bands (e.g., 2 kHz to 4 kHz). These processes, unlike conventional manual settings or simple rule-based processing by humans, involve dynamic optimization in high-dimensional feature space by machine learning models, resulting in essential improvements in computer technology such as improved voice analysis accuracy, reduced misrecognition rate, and ensured real-time performance. As a technical effect, the voice analysis unit enables voice analysis optimized for the distributor's emotional state, greatly improving the accuracy of telop generation and utterance recognition. Specific application fields include live streaming distribution, virtual events, e-sports commentary, remote education, virtual conferences, and other diverse use cases requiring real-time and high-precision voice analysis.

The voice analysis unit can detect changes in the tone and pitch of the distributor's voice in real time and reflect the detection in the analysis result. Specific detection methods and criteria for changes in tone and pitch may include, for example, analysis of audio waveforms and frequency analysis, but are not limited thereto. The voice analysis unit, for example, detects in real time when the tone of the distributor's voice becomes higher and changes the telop font to bold. When the pitch of the distributor's voice becomes lower, the voice analysis unit detects the change in real time and may reduce the telop font size. Furthermore, when the tone or pitch of the distributor's voice changes rapidly, the voice analysis unit detects the change in real time and may change the telop color. By detecting changes in the tone and pitch of the distributor's voice in real time, the font and style of the telop can be dynamically changed. Specifically, the voice analysis unit acquires the distributor's audio signal at a sampling rate of 16 kHz or higher and inputs it as PCM data. The voice analysis unit performs short-time Fourier transform (STFT) and Mel-frequency cepstral coefficient (MFCC) extraction on the input audio data and calculates feature quantities such as average frequency, fundamental frequency F0, formant distribution, and spectral envelope for each frame. The voice analysis unit analyzes these feature vectors (e.g., 128 dimensions) in a time series and uses autoregressive models, recurrent neural networks (RNN), or Transformer models with self-attention mechanisms to detect change points in tone and pitch. For example, when a normal speaker suddenly speaks in a high pitch, the model detects the change point and outputs labels such as “tone rise event” or “pitch surge event.” Conversely, when speaking slowly in a low pitch, the output is “tone drop event” or “pitch drop event.” The voice analysis unit sends these event labels and change amount scores (e.g., continuous values from −1.0 to +1.0) to the display unit, which changes the telop font (e.g., bold, thin), size (e.g., large, small), and color (e.g., red, blue, green) in real time according to the received event. Furthermore, when rapid changes in tone or pitch are continuously detected, animation effects (e.g., flash, fade-in) can be applied to the telop. These processes, unlike conventional manual editing or simple threshold judgment by humans, involve dynamic change detection and optimization in high-dimensional feature space by machine learning models, resulting in essential improvements in computer technology such as enhanced real-time performance, accuracy, and visual diversity. As a technical effect, the distributor's vocal inflection and emotional changes can be instantly reflected in visual expressions, thereby enhancing viewer immersion and comprehension of the distribution content. Specific application fields include live distribution, virtual events, e-sports commentary, and remote education.

The voice analysis unit can analyze the intensity and speed of the distributor's voice and determine the display speed and emphasis method of the telop. Specific analysis methods and criteria for intensity and speed of the voice may include, for example, changes in volume and measurement of speaking rate, but are not limited thereto. The voice analysis unit, for example, analyzes the intensity of the distributor's voice and increases the display speed of the telop when the voice is strong. When the distributor's voice is weak, the voice analysis unit analyzes the intensity and may slow down the display speed of the telop. Furthermore, when the speed of the distributor's voice increases, the voice analysis unit analyzes the speed and may change the emphasis method of the telop. By adjusting the display speed and emphasis method of the telop according to the intensity and speed of the distributor's voice, visually effective telops can be provided. Specifically, the voice analysis unit acquires the distributor's audio signal at a sampling rate of 16 kHz or higher and inputs it as PCM data. The voice analysis unit performs short-time Fourier transform (STFT) and Mel-frequency cepstral coefficient (MFCC) extraction on the input audio data and calculates feature quantities such as RMS energy (volume), zero-crossing rate, and spectral envelope for each frame. For measuring speaking rate, a speech recognition model (e.g., CTC-based speech-to-text conversion) is used to count the number of characters or words per utterance unit and calculate the speaking rate per unit time (e.g., characters/second, words/second). The voice analysis unit analyzes these intensity and speed features in a time series and uses convolutional neural networks (CNN) or recurrent neural networks (RNN) to output labels such as “strong,” “weak,” “fast,” and “slow,” as well as scores (e.g., 0.0 to 1.0). For example, “loud volume and fast speaking rate” results in “strong and fast” labels and high scores, while “low volume and slow speaking rate” results in “weak and slow” labels and low scores. The voice analysis unit sends these output results to the display unit, which increases the display speed of the telop and changes the font to bold or emphasis color when “strong,” and slows down the display speed and changes the font to thin or pale color when “weak.” When “fast,” the display unit speeds up telop animation effects (e.g., slide-in, fade-in), and when “slow,” displays them slowly. These processes, unlike conventional manual editing or simple rule-based processing by humans, involve dynamic optimization in high-dimensional feature space by machine learning models, resulting in essential improvements in computer technology such as enhanced real-time performance, accuracy, and visual diversity. As a technical effect, the distributor's speech characteristics can be instantly reflected in visual expressions, thereby enhancing viewer immersion and comprehension of the distribution content. Specific application fields include live distribution, virtual events, e-sports commentary, and remote education.

The voice analysis unit can estimate the distributor's emotion and determine the priority of voice analysis based on the estimated emotion. Specific types of emotions and estimation methods may include, for example, emotion classification such as joy, sadness, and anger, and voice analysis algorithms, but are not limited thereto. The voice analysis unit, for example, estimates emotion using an emotion engine when the distributor is excited and sets the priority of voice analysis high. When the distributor is calm, the voice analysis unit estimates emotion using the emotion engine and may set the priority of voice analysis to medium. Furthermore, when the distributor is nervous, the voice analysis unit estimates emotion using the emotion engine and may set the priority of voice analysis low. By determining the priority of voice analysis based on the distributor's emotion, important analyses can be performed preferentially. Specifically, the voice analysis unit acquires the distributor's audio signal at a sampling rate of 16 kHz or higher and inputs it as PCM data. The voice analysis unit performs preprocessing such as short-time Fourier transform (STFT) and Mel-frequency cepstral coefficient (MFCC) extraction and generates feature vectors (e.g., 128 dimensions) such as tone, pitch, intensity, and spectral envelope. The voice analysis unit inputs these features into speech emotion recognition models such as convolutional neural networks (CNN), bidirectional long short-term memory networks (BiLSTM), or Transformer-based models, and obtains emotion labels such as “joy,” “sadness,” “anger,” “excited,” “calm,” and “nervous” (one-hot vectors or probability distributions), as well as emotion intensity scores (0.0 to 1.0). For example, “high pitch, loud volume, and fast speaking rate” results in an “excited” label and an intensity score of 0.85, while “low pitch, low volume, and slow speaking rate” results in a “calm” label and an intensity score of 0.25. The voice analysis unit dynamically changes the priority of each processing module (e.g., noise reduction, feature extraction, speech recognition, emotion emphasis processing) in the voice analysis pipeline according to the estimated emotion label and intensity score. For example, in the “excited” state, emotion emphasis processing and high-precision speech recognition are prioritized; in the “calm” state, standard speech recognition is prioritized; and in the “nervous” state, noise reduction and spectral emphasis processing are prioritized. This priority control, unlike conventional static pipelines or manual settings by humans, involves dynamic optimization by machine learning models, resulting in essential improvements in computer technology such as enhanced real-time performance, analysis accuracy, and overall system efficiency. As a technical effect, optimal voice analysis processing can be preferentially executed according to the distributor's emotional state, preventing the omission of important information and improving analysis accuracy. Specific application fields include live distribution, virtual events, e-sports commentary, and remote education.

The voice analysis unit can analyze background noise in the distributor's voice and correct the analysis result according to the noise level. Specific types of background noise and analysis methods may include, for example, environmental sounds and noise removal methods, but are not limited thereto. The voice analysis unit, for example, analyzes the noise level when the background noise in the distributor's voice is high and applies noise reduction to correct the analysis result. When the background noise in the distributor's voice is low, the voice analysis unit analyzes the noise level and may minimize noise reduction to correct the analysis result. Furthermore, when the background noise in the distributor's voice fluctuates, the voice analysis unit analyzes the noise level in real time and may apply dynamic noise reduction to correct the analysis result. By correcting the analysis result according to the background noise in the distributor's voice, more accurate analysis results can be obtained. Specifically, the voice analysis unit acquires the distributor's audio signal at a sampling rate of 16 kHz or higher and inputs it as PCM data. The voice analysis unit performs short-time Fourier transform (STFT) and Mel-frequency cepstral coefficient (MFCC) extraction on the input audio data and calculates feature quantities such as spectral envelope, noise floor, SNR (signal-to-noise ratio), and zero-crossing rate for each frame. The voice analysis unit inputs these feature vectors (e.g., 128 dimensions) into convolutional neural networks (CNN) or recurrent neural networks (RNN) to estimate the type of background noise (e.g., environmental sound, noise, sudden sound) and noise level (e.g., continuous value from 0.0 to 1.0). For example, when the air conditioner noise is loud, the output is an “environmental sound” label and a noise level of 0.8; when the room is quiet, the output is a “quiet” label and a noise level of 0.1. The voice analysis unit dynamically adjusts the parameters of noise reduction processing (e.g., spectral subtraction, Wiener filter, bandpass filter) according to the estimated noise level and corrects the analysis result (e.g., speech recognition result, emotion estimation result). When the noise is high, strong noise reduction is applied; when the noise is low, minimal processing is performed. When the noise level fluctuates, dynamic noise reduction is applied to each frame. These processes, unlike conventional static filter settings or manual correction by humans, involve dynamic optimization in high-dimensional feature space by machine learning models, resulting in essential improvements in computer technology such as improved voice analysis accuracy, reduced misrecognition rate, and ensured real-time performance. As a technical effect, high-precision voice analysis independent of the distribution environment becomes possible, improving the reliability of telop generation and utterance recognition. Specific application fields include live distribution, virtual events, e-sports commentary, and remote education.

The voice analysis unit can analyze characteristics of the distributor's voice and apply a telop style corresponding to a specific voice quality. Specific types of voice characteristics and analysis methods may include, for example, voice quality, timbre, and audio spectrum, but are not limited thereto. The voice analysis unit, for example, analyzes the characteristics when the distributor's voice is high-pitched and applies a bright-colored telop style. When the distributor's voice is low-pitched, the voice analysis unit analyzes the characteristics and may apply a dark-colored telop style. Furthermore, when the distributor's voice is mid-pitched, the voice analysis unit analyzes the characteristics and may apply a standard-colored telop style. By applying a telop style corresponding to the distributor's voice quality, visually consistent telops can be provided. Specifically, the voice analysis unit acquires the distributor's audio signal at a sampling rate of 16 kHz or higher and inputs it as PCM data. The voice analysis unit performs short-time Fourier transform (STFT) and Mel-frequency cepstral coefficient (MFCC) extraction on the input audio data and generates feature vectors (e.g., 128 dimensions) such as spectral envelope, formant distribution, harmonics ratio, and zero-crossing rate. The voice analysis unit inputs these features into convolutional neural networks (CNN) or Transformer models with self-attention mechanisms and outputs voice quality labels such as “high-pitched,” “mid-pitched,” and “low-pitched,” as well as timbre scores (e.g., 0.0 to 1.0). For example, when high-frequency components are dominant, the output is a “high-pitched” label and a score of 0.9; when low-frequency components are dominant, the output is a “low-pitched” label and a score of 0.8. The voice analysis unit sends these output results to the display unit, which applies a bright color (e.g., yellow, orange), font (e.g., Gothic), and decoration (e.g., bold) for the “high-pitched” label; a dark color (e.g., blue, gray), font (e.g., Mincho), and decoration (e.g., underline) for the “low-pitched” label; and a standard color (e.g., white, black) and standard font for the “mid-pitched” label. These processes, unlike conventional manual editing or simple rule-based processing by humans, involve dynamic optimization in high-dimensional feature space by machine learning models, resulting in essential improvements in computer technology such as enhanced real-time performance, accuracy, and visual diversity. As a technical effect, telop styles optimized for the distributor's voice quality can be automatically generated, thereby enhancing viewer immersion and comprehension of the distribution content. Specific application fields include live distribution, virtual events, e-sports commentary, and remote education.

The record reference unit can estimate the distributor's emotion and adjust the method of referring to past distribution records based on the estimated emotion. Specific types of emotions and estimation methods may include, for example, emotion classification such as joy, sadness, and anger, and voice analysis algorithms, but are not limited thereto. The record reference unit, for example, estimates emotion using an emotion engine when the distributor is excited and speeds up the method of referring to past distribution records. When the distributor is calm, the record reference unit estimates emotion using the emotion engine and may standardize the method of referring to past distribution records. Furthermore, when the distributor is nervous, the record reference unit estimates emotion using the emotion engine and may detail the method of referring to past distribution records. By adjusting the method of referring to past distribution records based on the distributor's emotion, more appropriate reference results can be obtained. Specifically, the record reference unit inputs feature vectors (e.g., 128-dimensional MFCC, spectral envelope, pitch, intensity, etc.) extracted from the distributor's audio signal into a speech emotion recognition model (e.g., CNN, BiLSTM, Transformer-based) and obtains emotion labels such as “joy,” “sadness,” “anger,” “excited,” “calm,” and “nervous” (one-hot vectors or probability distributions) and emotion intensity scores (0.0 to 1.0). For example, when the input is a voice with “high pitch, loud volume, and fast speaking rate,” the output is an “excited” label and an intensity score of 0.85. Conversely, for “low pitch, low volume, and slow speaking rate,” the output is a “calm” label and an intensity score of 0.25. The record reference unit dynamically changes the query method and search algorithm parameters for the past distribution record database according to the estimated emotion label and intensity score. For example, in the “excited” state, fast index search and cache utilization are prioritized, and recent distribution records or emotionally similar segments are preferentially extracted. In the “calm” state, standard full-text search and average reference range are used; in the “nervous” state, detailed metadata search and chronological context tracking are enhanced. Furthermore, when the emotion intensity is high, emotionally matching parts are preferentially extracted from past distribution records, and when the intensity is low, overall trend analysis is emphasized. These processes, unlike conventional static searches or manual referencing by humans, involve dynamic optimization in high-dimensional feature space by machine learning models, resulting in essential improvements in computer technology such as faster reference speed, improved search accuracy, and extraction of highly relevant information. As a technical effect, reference to past records optimized for the distributor's emotional state improves real-time performance and contextual relevance, greatly enhancing the quality of telop generation and distribution production. Specific application fields include live streaming distribution, virtual events, e-sports commentary, remote education, virtual conferences, and other diverse use cases requiring information presentation according to emotional changes.

The record reference unit can extract specific keywords or phrases from past distribution records and determine the style of the telop according to their frequency. Specific extraction methods and criteria for keywords or phrases may include, for example, frequency analysis and co-occurrence network analysis, but are not limited thereto. The record reference unit, for example, extracts frequently used keywords from past distribution records and applies a specific font style to those keywords. The record reference unit may also extract specific phrases from past distribution records and apply a specific color to those phrases. Furthermore, the record reference unit may extract frequently used keywords or phrases from past distribution records and change the display method of the telop according to their frequency. By extracting specific keywords or phrases from past distribution records, telop styles can be provided according to their frequency. Specifically, the record reference unit acquires video file audio transcripts, text chat logs, distribution metadata, and other past distribution records from a database and performs frequency analysis of utterance content, key phrase extraction, and co-occurrence network analysis using natural language processing models (e.g., Transformer-based contextual embedding models, BERT, Word2Vec, etc.). Input data examples include utterance texts such as “Thank you for your hard work,” “Nice play,” and “See you next week,” and the model analyzes the frequency and co-occurrence relationships of these phrases. The output includes frequency scores for each keyword or phrase (e.g., 0 to 100 times), co-occurrence scores (e.g., 0.0 to 1.0), and importance labels (e.g., “high frequency,” “medium frequency,” “low frequency”). For example, if “Thank you for your hard work” appears 50 times, “Nice play” 30 times, and “See you next week” 10 times, “high frequency,” “medium frequency,” and “low frequency” labels are assigned, respectively. The record reference unit dynamically determines the telop's font (e.g., handwritten style for high frequency, Gothic for medium frequency, Mincho for low frequency), color (e.g., blue for high frequency, green for medium frequency, gray for low frequency), size (e.g., 36 pt for high frequency, 24 pt for medium frequency, 18 pt for low frequency), and decoration (e.g., bold for high frequency, underline for medium frequency, standard for low frequency) according to these labels and scores, and instructs the display unit. Furthermore, co-occurrence network analysis enables highly related phrases to be grouped together and the same style to be applied. These processes, unlike conventional simple rule-based or manual editing by humans, involve dynamic optimization in high-dimensional feature space by machine learning models, resulting in essential improvements in computer technology such as improved telop generation accuracy, ensured visual diversity, and enhanced real-time performance. As a technical effect, emphasizing phrases that reflect the distributor's utterance trends and phrases memorable to viewers enhances viewer comprehension and immersion, improving the quality of the distribution experience. Specific application fields include live distribution, virtual events, e-sports commentary, and remote education.

The record reference unit can analyze portions of past distribution records that received particularly positive viewer reactions and preferentially apply their style. Specific analysis methods and criteria for portions with positive viewer reactions may include, for example, viewer comments, view counts, and number of likes, but are not limited thereto. The record reference unit, for example, analyzes portions of past distribution records that received positive viewer reactions and applies their style to the current distribution. The record reference unit may also analyze portions of past distribution records with many viewer comments and preferentially apply their style. Furthermore, the record reference unit may analyze portions of past distribution records with particularly positive viewer reactions and emphasize their style. By preferentially applying the style of portions with positive viewer reactions, visually attractive telops can be provided to viewers. Specifically, the record reference unit acquires video file playback counts, chat log comment counts, reaction counts (e.g., likes, hearts, applause), and timestamped viewer behavior logs from the past distribution record database. The record reference unit aggregates these data in a time series and uses natural language processing models (e.g., Transformer-based sentiment analysis models, LSTM for time series clustering) to extract viewer reaction scores (e.g., 0.0 to 1.0), comment sentiment labels (e.g., positive, neutral, negative), and reaction peak times for each distribution segment. Input examples include “10:05-10:10: 50 comments, 30 likes, positive rate 0.8” and “10:20-10:25: 10 comments, 2 likes, positive rate 0.3.” The output includes labels and scores such as “high reaction segment from 10:05 to 10:10” and “low reaction segment from 10:20 to 10:25.” The record reference unit preferentially applies the style of high reaction segments (e.g., bold, bright color, large font, animation effects) to the current distribution telop, and sets the style of low reaction segments to standard or subdued. Furthermore, by analyzing the content of viewer comments, when specific keywords or phrases are frequently used, the style related to those phrases can be emphasized. These processes, unlike conventional manual editing or simple rule-based processing by humans, involve dynamic optimization in high-dimensional feature space by machine learning models, resulting in essential improvements in computer technology such as improved telop generation accuracy, visual consistency and diversity, and enhanced real-time performance. As a technical effect, telop generation reflecting viewer reactions enhances viewer immersion and comprehension of the distribution content, improving the quality of the distribution experience. Specific application fields include live distribution, virtual events, e-sports commentary, and remote education.

The record reference unit can estimate the distributor's emotion and adjust the frequency of referring to past distribution records based on the estimated emotion. Specific types of emotions and estimation methods may include, for example, emotion classification such as joy, sadness, and anger, and voice analysis algorithms, but are not limited thereto. The record reference unit, for example, estimates emotion using an emotion engine when the distributor is excited and sets the frequency of referring to past distribution records high. When the distributor is calm, the record reference unit estimates emotion using the emotion engine and may set the frequency of referring to past distribution records to medium. Furthermore, when the distributor is nervous, the record reference unit estimates emotion using the emotion engine and may set the frequency of referring to past distribution records low. By adjusting the frequency of referring to past distribution records based on the distributor's emotion, more appropriate reference results can be obtained. Specifically, the record reference unit inputs feature vectors (e.g., 128-dimensional MFCC, spectral envelope, pitch, intensity, etc.) extracted from the distributor's audio signal into a speech emotion recognition model (e.g., CNN, BiLSTM, Transformer-based) and obtains emotion labels such as “excited,” “calm,” and “nervous” and emotion intensity scores (0.0 to 1.0). For example, “high pitch, loud volume, and fast speaking rate” results in an “excited” label and a score of 0.85, while “low pitch, low volume, and slow speaking rate” results in a “calm” label and a score of 0.25. The record reference unit dynamically adjusts the query issuance frequency, cache update frequency, and search range for the past distribution record database according to the estimated emotion label and intensity score. For example, in the “excited” state, the latest records are referenced every second; in the “calm” state, every 10 seconds; and in the “nervous” state, every 30 seconds, achieving both real-time performance and load balancing. Furthermore, when the emotion intensity is high, recent distribution records or emotionally matching segments are preferentially referenced at high frequency, and when the intensity is low, overall trend analysis is emphasized. These processes, unlike conventional static reference frequency settings or manual control by humans, involve dynamic optimization in high-dimensional feature space by machine learning models, resulting in essential improvements in computer technology such as improved reference accuracy, optimized system load, and ensured real-time performance. As a technical effect, optimal information referencing according to the distributor's emotional state becomes possible, improving the quality of telop generation and distribution production. Specific application fields include live streaming distribution, virtual events, e-sports commentary, remote education, and virtual conferences.

The record reference unit can preferentially refer to portions of past distribution records related to specific events or topics. Specific types of events or topics and reference methods may include, for example, event types and topic classification methods, but are not limited thereto. The record reference unit, for example, preferentially refers to portions of past distribution records related to specific events and applies their style to the current distribution. The record reference unit may also preferentially refer to portions of past distribution records related to specific topics and apply their style to the current distribution. Furthermore, the record reference unit may analyze portions of past distribution records related to specific events or topics and emphasize their style. By preferentially referring to portions related to specific events or topics, telops highly relevant to viewers can be provided. Specifically, the record reference unit acquires event metadata (e.g., event name, date and time, topic tags), utterance text, and viewer comments from the past distribution record database and uses natural language processing models (e.g., Transformer-based topic classification models, LDA, BERT, etc.) to assign event/topic labels to each utterance or segment. Input examples include event names such as “2023 e-sports tournament,” “new product launch,” “Q&A session,” and topic tags such as “strategy,” “impressions,” and “questions.” The output includes event/topic labels for each segment (e.g., “e-sports,” “Q&A”), relevance scores (e.g., 0.0 to 1.0), and priority labels (e.g., “high,” “medium,” “low”). The record reference unit preferentially refers to portions with high relevance scores according to the current distribution content or user interest and applies their style (e.g., event-specific color, topic-specific font, emphasis decoration) to the current telop. Furthermore, when multiple portions related to specific events or topics exist, co-occurrence network analysis enables highly related groups to be extracted and the same style to be applied. These processes, unlike conventional manual editing or simple rule-based processing by humans, involve dynamic optimization in high-dimensional feature space by machine learning models, resulting in essential improvements in computer technology such as improved telop generation accuracy, visual consistency and diversity, and enhanced real-time performance. As a technical effect, telop generation tailored to viewer interest and distribution content becomes possible, enhancing viewer comprehension and immersion. Specific application fields include live distribution, virtual events, e-sports commentary, and remote education.

The record reference unit can analyze viewer comments in past distribution records and determine the style of the telop based on the content of the comments. Specific analysis methods and criteria for viewer comments may include, for example, content analysis and sentiment analysis of comments, but are not limited thereto. The record reference unit, for example, analyzes viewer comments in past distribution records and sets the style to a bright color when there are many positive comments. The record reference unit may also analyze viewer comments in past distribution records and set the style to a dark color when there are many negative comments. Furthermore, the record reference unit may analyze viewer comments in past distribution records and change the font or style of the telop based on the content of the comments. By determining the style of the telop based on viewer comments, telops reflecting viewer reactions can be provided. Specifically, the record reference unit acquires timestamped viewer comment logs (e.g., text data, comment posting time, user ID, reaction information, etc.) from the past distribution record database. The record reference unit uses natural language processing models (e.g., Transformer-based sentiment analysis models, BERT, LSTM, etc.) to estimate the sentiment polarity (e.g., positive, negative, neutral) and sentiment intensity score (e.g., continuous value from −1.0 to +1.0) for each comment. Input data examples include comment texts such as “Awesome!”, “Boring”, “Moved”, and “Want to see more”, and the model analyzes these to output scores such as “Awesome!” as positive (+0.9), “Boring” as negative (−0.8), “Moved” as positive (+0.8), and “Want to see more” as positive (+0.7). The record reference unit aggregates the sentiment distribution of comments for each time interval and applies a bright color (e.g., yellow, orange), font (e.g., Gothic), and decoration (e.g., bold) to the telop when the positive ratio is high, and a dark color (e.g., blue, gray), font (e.g., Mincho), and decoration (e.g., underline) when the negative ratio is high. Furthermore, when specific keywords (e.g., “amazing,” “sad,” “funny”) are frequently included in the comment content, styles (e.g., emphasis color, animation effects) corresponding to those keywords can be assigned. Output examples include applying a bright color and large font when positive comments account for 80% in the 10:00-10:05 interval, and applying a dark color and standard font when negative comments account for 60% in the 10:10-10:15 interval. The record reference unit sends these analysis results to the display unit in real time, and the display unit renders the telop based on the received style information. These series of processes, unlike conventional manual editing or simple rule-based processing by humans, involve dynamic optimization in high-dimensional feature space by machine learning models, resulting in essential improvements in computer technology such as improved telop generation accuracy, ensured visual diversity, and enhanced real-time performance. As a technical effect, instantly reflecting viewer reactions in telops enhances the interactivity and immersion of the distribution experience and increases viewer engagement. Specific application fields include live streaming distribution, virtual events, e-sports commentary, remote education, virtual conferences, and other real-time distribution involving viewer participation.

The display unit can estimate the distributor's emotion and adjust the display method of the telop based on the estimated emotion. Specific types of emotions and estimation methods may include, for example, emotion classification such as joy, sadness, and anger, and voice analysis algorithms, but are not limited thereto. The display unit, for example, estimates emotion using an emotion engine when the distributor is excited and emphasizes the display method of the telop. When the distributor is calm, the display unit estimates emotion using the emotion engine and may standardize the display method of the telop. Furthermore, when the distributor is nervous, the display unit estimates emotion using the emotion engine and may simplify the display method of the telop. By adjusting the display method of the telop based on the distributor's emotion, visually effective telops can be provided. Specifically, the display unit receives emotion labels (e.g., “joy,” “sadness,” “anger,” “excited,” “calm,” “nervous,” etc., as one-hot vectors or probability distributions) and emotion intensity scores (e.g., real values from 0.0 to 1.0) from the voice analysis unit as input. Input examples include an “excited” label and an intensity score of 0.85, or a “calm” label and an intensity score of 0.25. The display unit dynamically determines telop display method parameters (e.g., font size, color, decoration, animation effect, display position, display order, etc.) according to these input values. For example, in the “excited” state, the font size is increased, the color is brightened, and animation effects (e.g., flash, bounce) are added; in the “calm” state, standard size, standard color, and simple display are used; and in the “nervous” state, subdued color, small font, and static display without animation are used. Output examples include red, 36 pt, bold, and flash effect for “excited”; blue, 24 pt, standard font for “calm”; and gray, 18 pt, thin font for “nervous.” The display unit passes these parameters to a 2D/3D graphics engine using a GPU and renders the telop in real time. Furthermore, when the emotion intensity score is high, the degree of emphasis is increased, and when it is low, a subdued display is used, enabling continuous adjustment. These processes, unlike conventional static display settings or manual adjustment by humans, involve dynamic optimization in high-dimensional feature space by machine learning models, resulting in essential improvements in computer technology such as enhanced real-time performance, visual diversity, and consistency with distribution content. As a technical effect, the distributor's emotional changes can be instantly reflected in visual expressions, thereby enhancing viewer immersion and comprehension of the distribution content and improving the quality of the distribution experience. Specific application fields include live distribution, virtual events, e-sports commentary, remote education, and virtual conferences.

The display unit can dynamically change the display position of the telop and guide the viewer's gaze. Specific methods and criteria for dynamic changes include, for example, viewer gaze tracking and position adjustment according to content changes, but are not limited to such examples. For instance, the display unit can dynamically change the display position of the telop to be near the distributor's face, thereby guiding the viewer's gaze. Additionally, the display unit can dynamically change the display position of the telop to the center of the screen to focus the viewer's gaze, or to the edge of the screen to disperse the viewer's gaze. By dynamically changing the display position of the telop, the viewer's gaze can be effectively guided. Specifically, the display unit receives gaze coordinate data (e.g., x, y position on the screen, gaze duration, gaze movement vector, etc.) and content change information (e.g., distributor's face position, coordinates of moving objects, attention score, etc.) obtained from a user gaze tracking unit or content analysis unit as input. Examples of input include “user gaze concentrated at the top left of the screen (x=100, y=50)” and “distributor face position at the center (x=640, y=360)”. Based on these input values, the display unit dynamically determines telop display position parameters (e.g., x, y coordinates, display priority, stacking order). For example, if the gaze is concentrated on the left side of the screen, the telop is placed on the left; if concentrated in the center, it is placed in the center; if a specific area is being watched, the telop is placed near that area. Furthermore, when multiple telops are displayed simultaneously, they are arranged to avoid overlap, with important telops displayed prominently at the center of the gaze and supplementary telops displayed smaller at the edge of the screen. Examples of output include “display telop A largely at x=200, y=100” and “display telop B small at x=1200, y=700”. The display unit passes these parameters to the GPU graphics engine to render the telop in real time. Unlike conventional static display position settings or manual adjustments, these processes involve dynamic optimization in a high-dimensional feature space using machine learning models and gaze tracking technology, resulting in essential improvements in computer technology such as increased gaze guidance accuracy, visual diversity, and real-time performance. The technical effect is that viewers' attention can be effectively guided, enhancing their understanding and immersion in the distributed content. Specific application fields include live streaming, virtual events, e-sports commentary, remote education, and virtual conferences.

The display unit can adjust the display time of the telop and determine the optimal display timing according to the distribution content. Specific criteria and methods for determining the optimal display timing include, for example, the timing of utterances and viewer reactions, but are not limited to such examples. For instance, when the distribution content is important, the display unit sets a longer display time for the telop. When the content is light, the display time can be set shorter. Furthermore, when the distribution content fluctuates, the display time of the telop can be dynamically adjusted. By adjusting the display time of the telop, optimal display timing according to the distribution content can be provided. Specifically, the display unit receives as input the importance score of the utterance content (e.g., continuous value from 0.0 to 1.0), utterance type label (e.g., “important”, “supplementary”, “chat”, etc.), and real-time viewer reaction data (e.g., number of comments, number of likes, attention score) from the voice analysis unit and record reference unit. Examples of input include “Utterance A: importance 0.9, 50 comments” and “Utterance B: importance 0.3, 5 comments”. Based on these input values, the display unit dynamically determines telop display time parameters (e.g., display seconds, fade-in/out timing, animation duration). For example, when the utterance is highly important or viewer reactions are many, the display time is set longer (e.g., 10 seconds); when importance is low or reactions are few, it is set shorter (e.g., 3 seconds). Furthermore, when the distribution content fluctuates, the display time is adjusted in real time according to changes in utterance content and viewer reactions. Examples of output include “display telop for Utterance A for 10 seconds” and “display telop for Utterance B for 3 seconds”. The display unit passes these parameters to the GPU graphics engine to render the telop in real time. Unlike conventional static display time settings or manual adjustments, these processes involve dynamic optimization in a high-dimensional feature space using machine learning models and real-time data analysis, resulting in essential improvements in computer technology such as optimization of display timing, visual diversity, and real-time performance. The technical effect is that optimal telop display according to distribution content and viewer interest becomes possible, improving viewer understanding and immersion. Specific application fields include live streaming, virtual events, e-sports commentary, remote education, and virtual conferences.

The display unit can estimate the distributor's emotion and adjust the display order of the telop based on the estimated emotion. Specific types and estimation methods of emotion include, for example, emotion classification such as joy, sadness, anger, and voice analysis algorithms, but are not limited to such examples. For instance, when the distributor is excited, the emotion engine is used to estimate the emotion and the display order of the telop is set with priority. When the distributor is calm, the emotion engine is used to estimate the emotion and the display order of the telop is set in a standard manner. Furthermore, when the distributor is nervous, the emotion engine is used to estimate the emotion and the display order of the telop is set simply. By adjusting the display order of the telop based on the distributor's emotion, visually effective telops can be provided. Specifically, the display unit receives as input emotion labels (e.g., “excited”, “calm”, “nervous” as one-hot vectors or probability distributions) and emotion intensity scores (e.g., real values from 0.0 to 1.0) from the voice analysis unit. Examples of input include an “excited” label with an intensity score of 0.85 and a “calm” label with an intensity score of 0.25. Based on these input values, the display unit dynamically determines telop display order parameters (e.g., priority score, display queue order, stacking order). For example, in an “excited” state, important telops are displayed with priority at the front and center, and supplementary telops are displayed later. In a “calm” state, telops are displayed in standard order, and in a “nervous” state, telops are displayed simply and modestly. Examples of output include displaying important telops at the front and center during “excited” states, displaying in chronological order during “calm” states, and omitting supplementary telops during “nervous” states. The display unit passes these parameters to the GPU graphics engine to render the telop in real time. Unlike conventional static display order settings or manual adjustments, these processes involve dynamic optimization in a high-dimensional feature space using machine learning models, resulting in essential improvements in computer technology such as optimization of display order, visual diversity, and real-time performance. The technical effect is that optimal telop display according to the distributor's emotional state becomes possible, improving viewer understanding and immersion. Specific application fields include live streaming, virtual events, e-sports commentary, remote education, and virtual conferences.

The display unit can change the display color of the telop according to the distribution content or viewer preferences. Specific types and acquisition methods of viewer preferences include, for example, viewing history and survey results, but are not limited to such examples. For instance, when the distribution content is bright, the display unit changes the telop color to a bright color. When the content is dark, the telop color can be changed to a dark color. Furthermore, the display color of the telop can be customized according to viewer preferences. By changing the display color of the telop according to the distribution content or viewer preferences, visually attractive telops can be provided. Specifically, the display unit receives as input distribution content features (e.g., brightness score, atmosphere label, genre classification) and viewer preference features (e.g., color preference vector extracted from past viewing history, color selection label from survey responses, user setting values) from the distribution content analysis unit and viewer profile management unit. The display unit inputs these values into a multilayer perceptron or Transformer-based recommendation model and generates telop color parameters (e.g., RGB values, hue/saturation/brightness scores, color palette ID) as output. For example, if the distribution content is bright (brightness 0.8) and the viewer preference is warm colors (red/orange), the output color code is “#FFAA33 (orange)”. Conversely, if the distribution content is dark (brightness 0.3) and the viewer preference is cool colors (blue/green), the output is “#3366CC (blue)”. Furthermore, when multiple viewers participate simultaneously, a clustering algorithm can be used to determine a representative color, or personalized colors can be assigned to each user. The display unit passes these color parameters to the GPU graphics engine to render the telop in real time. As a subsequent process, contrast ratio and visibility evaluation models can be applied to automatically adjust the balance with the background video. Unlike conventional static color settings or manual adjustments, these processes involve dynamic optimization in a high-dimensional feature space using machine learning models, resulting in essential improvements in computer technology such as visual diversity, personalization, and real-time performance. The technical effect is that optimal telop colors tailored to the distribution content and viewer preferences can be automatically generated, improving viewer immersion and understanding of the distributed content, and enhancing the quality of the distribution experience. Specific application fields include live streaming distribution, virtual events, e-sports commentary, remote education, virtual conferences, and other diverse use cases requiring visual interaction and personalization.

The display unit can optimize the display font of the telop for the viewer's device. Specific methods and criteria for optimizing for the viewer's device include, for example, device resolution and screen size, but are not limited to such examples. For instance, when the viewer is using a smartphone, the display unit optimizes the telop font by making it smaller. When the viewer is using a tablet, the telop font can be optimized to a medium size. Furthermore, when the viewer is using a large display, the telop font can be optimized to a larger size. By optimizing the display font of the telop for the viewer's device, visually easy-to-read telops can be provided. Specifically, the display unit acquires device information (e.g., screen resolution, screen size, pixel density, OS type, browser information) sent from the viewer's terminal and determines the device type (e.g., smartphone, tablet, notebook PC, desktop, TV) using a terminal profile analysis unit. The display unit determines optimal font size (e.g., smartphone 16 pt, tablet 24 pt, TV 36 pt), font family (e.g., sans-serif for readability, Mincho, etc.), line spacing, character spacing, and anti-aliasing settings for each device type. For example, for “Device: iPhone 13 (1170×2532)”, the font size is 16 pt; for “Device: iPad (2048×2732)”, it is 24 pt; for “Device: 4K TV (3840×2160)”, it is 36 pt. Furthermore, if the user selects large text in accessibility settings or enables high-contrast mode for visually impaired users, these settings can be prioritized and font parameters overwritten. The display unit passes the determined font parameters to the GPU graphics engine to render the telop in real time. As a subsequent process, a screen layout optimization algorithm automatically adjusts the arrangement and overlap of telops to ensure visibility even when multiple telops are displayed simultaneously. Unlike conventional static font settings or manual adjustments, these processes involve dynamic optimization based on terminal information, resulting in essential improvements in computer technology such as readability, accessibility, and real-time performance. The technical effect is that telop display optimized for the viewer's device environment improves visibility and understanding, enabling a comfortable distribution experience across a wide range of devices. Specific application fields include live streaming distribution, virtual events, e-sports commentary, remote education, virtual conferences, and other diverse use cases requiring multi-device support.

The speech display unit can estimate the user's emotion and adjust the display method of the speech balloon based on the estimated emotion. Specific types and estimation methods of emotion include, for example, emotion classification such as joy, sadness, anger, and voice analysis algorithms, but are not limited to such examples. For instance, when the user is excited, the emotion engine is used to estimate the emotion and the display method of the speech balloon is emphasized. When the user is calm, the emotion engine is used to estimate the emotion and the display method of the speech balloon is standardized. Furthermore, when the user is nervous, the emotion engine is used to estimate the emotion and the display method of the speech balloon is made simple. By adjusting the display method of the speech balloon based on the user's emotion, visually effective speech balloons can be provided. Specifically, the speech display unit acquires the user's speech audio signal (e.g., PCM data at 16 kHz or higher) or text input and inputs it into a voice emotion recognition model (e.g., CNN, BiLSTM, Transformer-based) or a natural language emotion analysis model. Examples of input include audio with “high pitch, loud volume, fast speech rate” and text such as “I'm happy!”, with output being emotion labels such as “joy”, “excitement”, “sadness”, “nervousness” (one-hot vectors or probability distributions) and emotion intensity scores (0.0 to 1.0). For example, for “I'm happy!”, the output is a “joy” label and an intensity score of 0.9; for “Oh . . . ”, the output is a “sadness” label and an intensity score of 0.7. The speech display unit dynamically determines speech balloon display method parameters (e.g., color, font, size, animation effect, display position) according to these output values. For example, in an “excited” state, bright colors, large fonts, and bounce animation are used; in a “calm” state, standard colors, standard fonts, and static display; in a “nervous” state, subdued colors, small fonts, and fade-in display. As a subsequent process, continuous adjustment is possible, such as increasing emphasis when emotion intensity is high and making the display more modest when it is low. Unlike conventional static speech balloon display or manual adjustments, these processes involve dynamic optimization in a high-dimensional feature space using machine learning models, resulting in essential improvements in computer technology such as real-time performance, visual diversity, and enhanced user experience. The technical effect is that changes in user emotion can be immediately reflected in visual expression, improving the sense of presence and immersion in communication and enhancing the dialogue experience in virtual spaces. Specific application fields include virtual events, e-sports commentary, remote education, virtual conferences, and other real-time communication scenarios where emotional expression is important.

The speech display unit can dynamically change the shape and size of the speech balloon according to the content of the user's utterance. Specific methods and criteria for changing the shape and size of the speech balloon include, for example, the length of the utterance and emphasized portions, but are not limited to such examples. For instance, when the user's utterance is long, the shape of the speech balloon is changed to a rectangle and the size is increased. When the user's utterance is short, the shape is changed to a circle and the size is reduced. Furthermore, when the user's utterance is in question format, the shape is changed to an angular form and the size is appropriately adjusted. By dynamically changing the shape and size of the speech balloon according to the content of the user's utterance, visually effective speech balloons can be provided. Specifically, the speech display unit receives the user's utterance text or speech recognition result (e.g., CTC-based speech-to-text conversion) as input and uses a natural language processing model (e.g., Transformer-based context analysis model) to extract utterance length (number of characters/words), sentence type (e.g., interrogative, exclamatory, declarative), and emphasized portions (e.g., exclamation marks, question marks, emphasized words). Examples of input include “Hello!” (short, exclamatory), “How do I use this feature?” (medium, interrogative), and “Thank you for joining us today. We look forward to seeing you next time.” (long, declarative). Output includes utterance length label (short, medium, long), sentence type label (question, exclamation, declarative), and emphasis score (0.0 to 1.0). Based on these output values, the speech display unit dynamically determines the shape of the speech balloon (e.g., circle for short sentences, rounded rectangle for medium sentences, rectangle for long sentences, angular shape for questions), size (automatically enlarged according to the number of characters), color, and decoration, and renders them in real time using a 3D graphics engine. As a subsequent process, animation effects (e.g., pop-up, bounce) can be added according to changes in utterance content, and optimization is performed to avoid overlap when multiple user utterances are displayed simultaneously. Unlike conventional static speech balloon designs or manual editing, these processes involve dynamic optimization in a high-dimensional feature space using machine learning models, resulting in essential improvements in computer technology such as real-time performance, visual diversity, and enhanced user experience. The technical effect is that optimal speech balloon display according to utterance content improves viewer understanding and immersion, enhancing the communication experience in virtual spaces. Specific application fields include virtual events, e-sports commentary, remote education, virtual conferences, and other diverse use cases requiring dynamic visual expression according to utterance content.

The speech display unit can analyze emphasized portions of the user's utterance and perform emphasis display within the speech balloon. Specific methods and criteria for analyzing emphasized portions include, for example, intensity of the voice and importance of the utterance, but are not limited to such examples. For instance, the speech display unit analyzes portions of the user's utterance that should be emphasized and displays those portions in bold. It can also analyze important keywords in the user's utterance and display those portions in color. Furthermore, it can analyze particularly emphasized portions and display those portions in a larger font. By analyzing emphasized portions of the user's utterance and performing emphasis display within the speech balloon, visually effective speech balloons can be provided. Specifically, the speech display unit acquires the user's speech audio signal (e.g., PCM data at 16 kHz or higher) or text data and inputs it into a voice emphasis analysis model (e.g., CNN, BiLSTM, Transformer-based) or a natural language processing model (e.g., key phrase extraction, importance scoring). Examples of input include speech or text such as “This is absolutely important!”, and the model determines the portion “absolutely important” as highly emphasized. Output includes index ranges of emphasized portions (e.g., character positions 5-10), emphasis score (0.0 to 1.0), and keyword labels (e.g., “important”). Based on these output values, the speech display unit displays the corresponding portions in bold, color, or large font within the speech balloon, while other portions are displayed in standard style. Furthermore, animation effects (e.g., bounce, flash) can be added to emphasized portions according to voice intensity and intonation. As a subsequent process, when multiple emphasized portions exist, the degree of emphasis can be varied according to priority, and users can customize the presence or style of emphasis display. Unlike conventional manual editing or simple rule-based processing, these processes involve dynamic optimization in a high-dimensional feature space using machine learning models, resulting in essential improvements in computer technology such as real-time performance, visual diversity, and enhanced user experience. The technical effect is that important portions of utterances can be visually emphasized immediately, improving viewer understanding and immersion, and enhancing the communication experience in virtual spaces. Specific application fields include virtual events, e-sports commentary, remote education, virtual conferences, and other real-time distribution scenarios where emphasis expression is important.

The speech display unit can estimate the user's emotion and adjust the display order of the speech balloon based on the estimated emotion. Specific types and estimation methods of emotion include, for example, emotion classification such as joy, sadness, anger, and voice analysis algorithms, but are not limited to such examples. For instance, when the user is excited, the emotion engine is used to estimate the emotion and the display order of the speech balloon is set with priority. When the user is calm, the emotion engine is used to estimate the emotion and the display order of the speech balloon is set in a standard manner. Furthermore, when the user is nervous, the emotion engine is used to estimate the emotion and the display order of the speech balloon is set simply. By adjusting the display order of the speech balloon based on the user's emotion, visually effective speech balloons can be provided. Specifically, the speech display unit acquires the user's speech audio or text data and inputs it into a voice emotion recognition model (e.g., CNN, BiLSTM, Transformer-based) or a natural language emotion analysis model. Examples of input include audio or text such as “Yay!” and “Hmm . . . ”, with output being emotion labels such as “excited”, “calm”, “nervous” (one-hot vectors or probability distributions) and emotion intensity scores (0.0 to 1.0). Based on these output values, the speech display unit dynamically determines speech balloon display order parameters (e.g., priority score, display queue order, stacking order). For example, in an “excited” state, important speech balloons are displayed with priority at the front and center, and supplementary speech balloons are displayed later. In a “calm” state, speech balloons are displayed in standard order, and in a “nervous” state, speech balloons are displayed simply and modestly. As a subsequent process, when multiple users speak simultaneously, the display order can be optimized according to emotion intensity and importance of utterance content to prevent visual congestion and information overload. Unlike conventional static display order settings or manual adjustments, these processes involve dynamic optimization in a high-dimensional feature space using machine learning models, resulting in essential improvements in computer technology such as real-time performance, visual diversity, and enhanced user experience. The technical effect is that optimal speech balloon display according to the user's emotional state becomes possible, improving viewer understanding and immersion. Specific application fields include virtual events, e-sports commentary, remote education, virtual conferences, and other diverse use cases requiring optimization of emotional expression and information presentation.

The speech display unit can change the background color or border of the speech balloon according to the content of the user's utterance. Specific methods and criteria for changing the background color or border include, for example, the content of the utterance and the strength of emotion, but are not limited to such examples. For instance, when the user's utterance is positive, the background color of the speech balloon is changed to a bright color. When the utterance is negative, the background color can be changed to a dark color. Furthermore, when the utterance is in question format, the border of the speech balloon can be made thicker. By changing the background color or border of the speech balloon according to the content of the user's utterance, visually effective speech balloons can be provided. Specifically, the speech display unit acquires the user's utterance text or speech recognition result and uses a natural language processing model (e.g., Transformer-based emotion analysis model, BERT, LSTM, etc.) to estimate the emotional polarity of the utterance (e.g., positive, negative, neutral), emotion intensity score (−1.0 to +1.0), and sentence type (e.g., interrogative, exclamatory, declarative). Examples of input include “Amazing!” (positive +0.9), “Boring . . . ” (negative −0.8), and “Why?” (interrogative). Output includes emotion label, intensity score, and sentence type label. Based on these output values, the speech display unit dynamically determines the background color of the speech balloon (e.g., positive: yellow or orange; negative: blue or gray; neutral: white) and border (e.g., interrogative: thick line; exclamatory: dotted line; declarative: standard line), and renders them in real time using a 3D graphics engine. As a subsequent process, when emotion intensity is high, the saturation and brightness of the color can be emphasized, and when it is low, the color can be adjusted to be more subdued. Unlike conventional static speech balloon designs or manual editing, these processes involve dynamic optimization in a high-dimensional feature space using machine learning models, resulting in essential improvements in computer technology such as real-time performance, visual diversity, and enhanced user experience. The technical effect is that optimal speech balloon display according to utterance content and emotion improves viewer understanding and immersion, enhancing the communication experience in virtual spaces. Specific application fields include virtual events, e-sports commentary, remote education, virtual conferences, and other diverse use cases requiring dynamic visual expression according to emotion and context.

The speech display unit can analyze the context of the user's utterance and display related icons or emojis within the speech balloon. Specific methods and criteria for context analysis include, for example, preceding and following utterance content and related topics, but are not limited to such examples. For instance, when the user's utterance expresses joy, related emojis (e.g., smiley face) are displayed within the speech balloon. When the utterance expresses sadness, related emojis (e.g., tears) can be displayed. Furthermore, when the utterance expresses surprise, related icons (e.g., surprised face) can be displayed. By displaying related icons or emojis according to the context of the user's utterance, visually effective speech balloons can be provided. Specifically, the speech display unit acquires the user's utterance text or speech recognition result and uses a natural language processing model (e.g., Transformer-based context understanding model, BERT, LSTM, etc.) to analyze the emotional polarity of the utterance (e.g., joy, sadness, surprise, anger, neutral), topic classification (e.g., sports, learning, chat), and context of preceding and following sentences. Examples of input include “Yay!” (joy), “Sad . . . ” (sadness), and “What!?” (surprise), with output being emotion label, topic label, and context score. Based on these output values, the speech display unit automatically arranges icons or emojis corresponding to the emotion label or topic (e.g., joy: smiley face; sadness: tears; surprise: surprised face; sports: ball; learning: book) at appropriate positions within the speech balloon. Furthermore, according to the preceding and following utterance content and conversation flow, multiple related emojis can be combined and displayed. As a subsequent process, users can customize the presence or type of icon display, and alternative text can be added for visually impaired users. Unlike conventional manual editing or simple rule-based processing, these processes involve dynamic optimization in a high-dimensional feature space using machine learning models, resulting in essential improvements in computer technology such as real-time performance, visual diversity, and enhanced user experience. The technical effect is that optimal icon and emoji display according to utterance context and emotion improves viewer understanding and immersion, enhancing the communication experience in virtual spaces. Specific application fields include virtual events, e-sports commentary, remote education, virtual conferences, and other diverse use cases requiring visual interaction according to context.

The system according to the embodiment is not limited to the examples described above and can be variously modified as follows. Specifically, the system allows for multiple technical variations, including the architecture and learning methods of AI models, data flow, input/output specifications, hardware configuration, and user interface design. For example, in the voice analysis unit, different voice emotion recognition models such as convolutional neural networks, bidirectional long short-term memory networks, and Transformer models with self-attention mechanisms can be selected. In the record reference unit, various context analysis and topic classification models such as BERT, GPT series, LDA, and Word2Vec can be applied as natural language processing models. In the display unit and speech display unit, the types of 2D/3D graphics engines (e.g., OpenGL, Vulkan, WebGL), GPU cluster configurations, and rendering pipeline optimization methods (e.g., batch drawing, shader optimization) can be flexibly changed. Furthermore, additional or extended modules such as user profile management units, gaze tracking units, and accessibility support modules can be provided, enabling personalized telop and speech balloon display for each user, voice reading functions for visually impaired users, and synchronized display through multi-device collaboration, thereby realizing diverse embodiments. These variations enhance the system's scalability and flexibility, resulting in technical effects such as improved adaptability to future technological evolution and new use cases. Specific application fields include live streaming distribution, virtual events, e-sports commentary, remote education, virtual conferences, accessibility support, multi-device collaborative distribution, and other wide-ranging applications.

The real-time distribution system can further include a user gaze tracking unit. The gaze tracking unit can track the user's gaze in real time and dynamically change the display position of the telop based on the movement of the gaze. For example, when the user is looking at the left side of the screen, the telop is displayed on the left side of the screen. When the user is looking at the center of the screen, the telop can be displayed at the center of the screen. Furthermore, when the user is focusing on a specific area, information related to that area can be displayed as a telop. By dynamically changing the display position of the telop based on the user's gaze, visually effective telops can be provided. Specifically, the gaze tracking unit receives image data or infrared reflection data obtained from the user's terminal camera or dedicated gaze sensor as input and uses a gaze estimation model (e.g., CNN-based face/eye detection, landmark regression, self-supervised gaze vector estimation) to calculate the coordinates of the gaze point on the screen (e.g., x, y position, gaze duration, gaze movement vector) in real time. Examples of input include “camera image frame”, “face landmark coordinates”, and “pupil center position”, with output such as “gaze point x=320, y=180”, “gaze duration 500 ms”. The display unit receives these gaze data and dynamically determines telop display position parameters (e.g., x, y coordinates, display priority, stacking order). For example, if the user is focusing on the top left of the screen, the telop is placed at the top left; if focusing on the center, it is placed at the center; if focusing on a specific area, the telop is placed near that area. Furthermore, by aggregating gaze data from multiple users, a gaze heatmap can be generated and important telops can be placed in areas with high overall attention. As a subsequent process, when gaze movement is intense, animation effects (e.g., slide-in, fade-in) can be added to the telop, and when the gaze is fixed, static display can be used, enabling dynamic display control. Unlike conventional static display position settings or manual adjustments, these processes involve dynamic optimization in a high-dimensional feature space using machine learning models and gaze tracking technology, resulting in essential improvements in computer technology such as increased gaze guidance accuracy, visual diversity, and real-time performance. The technical effect is that viewers' attention can be effectively guided, enhancing their understanding and immersion in the distributed content. Specific application fields include live streaming, virtual events, e-sports commentary, remote education, virtual conferences, and other diverse use cases requiring gaze interaction.

The voice analysis unit can analyze the rhythm and tempo of the distributor's voice and adjust the display timing of the telop. For example, when the rhythm of the distributor's voice is fast, the display timing of the telop is made faster. When the rhythm is slow, the display timing can be made slower. Furthermore, when the tempo of the distributor's voice fluctuates, the display timing of the telop can be dynamically adjusted according to the fluctuation. By adjusting the display timing of the telop according to the rhythm and tempo of the distributor's voice, visually consistent telops can be provided. Specifically, the voice analysis unit acquires the distributor's audio signal (e.g., PCM data at 16 kHz or higher), performs preprocessing such as short-time Fourier transform (STFT) and Mel-frequency cepstral coefficient (MFCC) extraction, and inputs it into a voice rhythm analysis model (e.g., RNN, LSTM, autoregressive model). Examples of input include “fast rhythm (speech interval 0.2 seconds)” and “slow rhythm (speech interval 1.0 seconds)”, with output such as rhythm score (e.g., 0.0 to 1.0), tempo label (e.g., fast, normal, slow), and fluctuation score (e.g., rhythm fluctuation 0.3). Based on these output values, the voice analysis unit instructs the display unit on telop display timing parameters (e.g., display delay, display duration, animation speed). For example, when the rhythm is fast, the telop is displayed quickly; when slow, it is displayed slowly. When the tempo fluctuates, the display timing is dynamically adjusted for each utterance. As a subsequent process, the optimal display timing can be determined by combining the importance of the utterance content and viewer reactions. Unlike conventional static display timing settings or manual adjustments, these processes involve dynamic optimization in a high-dimensional feature space using machine learning models, resulting in essential improvements in computer technology such as real-time performance, visual consistency, and enhanced user experience. The technical effect is that optimal telop display according to the distributor's speech rhythm and tempo improves viewer understanding and immersion, enhancing the quality of the distribution experience. Specific application fields include live streaming distribution, virtual events, e-sports commentary, remote education, virtual conferences, and other diverse use cases requiring dynamic visual expression according to speech tempo.

The record reference unit can analyze viewer reactions from past distribution records and emphasize portions with good reactions. For example, the unit analyzes portions with many viewer comments and displays those portions in bold. It can also analyze portions with many “likes” and display those portions in color. Furthermore, it can analyze portions with particularly good reactions and display those portions in a larger font. By analyzing past distribution records based on viewer reactions, visually effective telops can be provided. Specifically, the record reference unit acquires viewer behavior data such as timestamped viewer comment logs, reaction counts (e.g., likes, hearts, applause), and playback counts from the past distribution record database, and inputs them into a time-series aggregation model or natural language processing model (e.g., Transformer-based emotion analysis model, LSTM-based time-series clustering). Examples of input include “10:05-10:10, 50 comments, 30 likes” and “10:20-10:25, 10 comments, 2 likes”, with output such as reaction score for each distribution segment (0.0 to 1.0), reaction peak time, and importance label (high, medium, low). Based on these output values, the record reference unit preferentially applies telop styles (e.g., bold, bright color, large font, animation effect) to portions with good reactions in the current distribution telop, and sets portions with low reactions to standard or subdued styles. Furthermore, by analyzing the sentiment of comment content, bright colors can be assigned when positive reactions are many, and dark colors when negative reactions are many. As a subsequent process, when multiple high-reaction segments exist, the display order and position can be optimized to prevent viewer interest from being dispersed. Unlike conventional manual editing or simple rule-based processing, these processes involve dynamic optimization in a high-dimensional feature space using machine learning models, resulting in essential improvements in computer technology such as real-time performance, visual diversity, and enhanced user experience. The technical effect is that telop generation reflecting viewer reactions improves viewer immersion and understanding of the distributed content, enhancing the quality of the distribution experience. Specific application fields include live streaming, virtual events, e-sports commentary, remote education, and other real-time distribution scenarios involving viewer participation.

The display unit can customize the display style of the telop according to user preferences. For example, when the user prefers bright colors, the display color of the telop is changed to a bright color. When the user prefers a specific font, that font can be applied to the telop. Furthermore, when the user prefers a specific style (e.g., bold, italic), that style can be applied to the telop. By customizing the display style of the telop according to user preferences, visually attractive telops can be provided. Specifically, the display unit receives user setting information (e.g., color preference vector, font selection label, style setting value, accessibility settings) obtained from the user profile management unit as input. Examples of input include “color preference: bright colors”, “font: Gothic”, “style: bold, italic”. Based on these input values, the display unit dynamically determines telop display color (e.g., yellow, orange), font (e.g., Gothic, Mincho), style (e.g., bold, italic, underline), size, animation effect, and other parameters, and renders them in real time using a GPU graphics engine. Furthermore, when the user registers multiple preferences, the style can be automatically switched according to the distribution content or time of day. As a subsequent process, when the user changes settings, the changes are immediately reflected, providing a personalized visual experience. Unlike conventional static style settings or manual adjustments, these processes involve dynamic optimization based on user profiles, resulting in essential improvements in computer technology such as personalization, visual diversity, and real-time performance. The technical effect is that optimal telop display according to user preferences improves viewer immersion and understanding of the distributed content, enhancing the quality of the distribution experience. Specific application fields include live streaming distribution, virtual events, e-sports commentary, remote education, virtual conferences, and other diverse use cases requiring personalization.

The speech display unit can apply animation effects to the speech balloon based on the content of the user's utterance. For example, when the user's utterance is positive, a pop-up animation is applied to the speech balloon. When the utterance is negative, a fade-in animation can be applied to the speech balloon. Furthermore, when the utterance is in question format, a bounce animation can be applied to the speech balloon. By applying animation effects to the speech balloon according to the content of the user's utterance, visually effective speech balloons can be provided. Specifically, the speech display unit acquires the user's utterance text or speech recognition result and uses a natural language processing model (e.g., Transformer-based emotion analysis model, BERT, LSTM, etc.) to estimate the emotional polarity of the utterance (e.g., positive, negative, neutral) and sentence type (e.g., interrogative, exclamatory, declarative). Examples of input include “Yay!” (positive), “Too bad . . . ” (negative), and “Why?” (interrogative), with output being emotion label and sentence type label. Based on these output values, the speech display unit dynamically determines animation effects for the speech balloon (e.g., positive: pop-up; negative: fade-in; interrogative: bounce; exclamatory: flash) and renders them in real time using a 3D graphics engine. Furthermore, animation speed and duration can be adjusted according to emotion intensity and utterance length. As a subsequent process, when multiple users speak simultaneously, animation overlap and timing can be optimized to prevent visual congestion. Unlike conventional static speech balloon display or manual editing, these processes involve dynamic optimization in a high-dimensional feature space using machine learning models, resulting in essential improvements in computer technology such as real-time performance, visual diversity, and enhanced user experience. The technical effect is that optimal animation effects according to utterance content and emotion improve viewer understanding and immersion, enhancing the communication experience in virtual spaces. Specific application fields include virtual events, e-sports commentary, remote education, virtual conferences, and other diverse use cases requiring dynamic visual expression.

The voice analysis unit can estimate the distributor's emotion and dynamically adjust voice filtering based on the estimated emotion. For example, when the distributor is excited, the emotion engine is used to estimate the emotion and noise reduction is enhanced. When the distributor is calm, the emotion engine is used to estimate the emotion and noise reduction is minimized. Furthermore, when the distributor is nervous, the emotion engine is used to estimate the emotion and specific frequency bands are emphasized. By dynamically adjusting voice filtering based on the distributor's emotion, more accurate voice analysis results can be obtained. Specifically, the voice analysis unit acquires the distributor's audio signal (e.g., PCM data at 16 kHz or higher), performs preprocessing such as short-time Fourier transform (STFT) and Mel-frequency cepstral coefficient (MFCC) extraction, and inputs it into a voice emotion recognition model (e.g., CNN, BiLSTM, Transformer-based). Examples of input include audio with “high pitch, loud volume, fast speech rate” and “low pitch, quiet volume, slow speech rate”, with output being emotion labels such as “excited”, “calm”, “nervous” (one-hot vectors or probability distributions) and emotion intensity scores (0.0 to 1.0). Based on these output values, the voice analysis unit dynamically adjusts parameters for voice filtering processing (e.g., noise reduction, equalization, spectral enhancement). For example, in an “excited” state, high-frequency components are emphasized and aggressive noise suppression is applied; in a “calm” state, low-frequency components are retained and the noise reduction threshold is relaxed; in a “nervous” state, specific frequency bands (e.g., 2 kHz-4 kHz) are emphasized. As a subsequent process, the filtered audio data is input into downstream modules such as voice recognition, emotion estimation, and telop generation to improve overall analysis accuracy. Unlike conventional static filter settings or manual correction, these processes involve dynamic optimization in a high-dimensional feature space using machine learning models, resulting in essential improvements in computer technology such as improved voice analysis accuracy, reduced misrecognition rate, and ensured real-time performance. The technical effect is that voice filtering optimized for the distributor's emotional state greatly improves the accuracy of telop generation and utterance recognition. Specific application fields include live streaming distribution, virtual events, e-sports commentary, remote education, virtual conferences, and other diverse use cases requiring real-time and high-precision voice analysis.

The voice analysis unit can detect changes in the tone and pitch of the distributor's voice in real time and reflect them in the analysis result. For example, when the tone of the distributor's voice rises, this change is detected in real time and the telop font is changed to bold. When the pitch of the distributor's voice lowers, this change is detected in real time and the telop font size is reduced. Furthermore, when the tone or pitch of the distributor's voice changes rapidly, this change is detected in real time and the telop color is changed. By detecting changes in the tone and pitch of the distributor's voice in real time, the font and style of the telop can be dynamically changed. Specifically, the voice analysis unit acquires the distributor's audio signal (e.g., PCM data at 16 kHz or higher), performs short-time Fourier transform (STFT) and Mel-frequency cepstral coefficient (MFCC) extraction, and calculates feature quantities such as average frequency, fundamental frequency F0, formant distribution, and spectral envelope for each frame. The voice analysis unit analyzes these feature vectors (e.g., 128 dimensions) in a time series and uses autoregressive models, recurrent neural networks (RNN), or Transformer models with self-attention mechanisms to detect change points in tone and pitch. For example, when a normal speaker suddenly speaks in a high pitch, the model detects the change point and outputs labels such as “tone rise event” or “pitch surge event”. Conversely, when speaking slowly in a low pitch, it outputs “tone drop event” or “pitch drop event”. The voice analysis unit sends these event labels and change amount scores (e.g., continuous values from −1.0 to +1.0) to the display unit, which changes the telop font (e.g., bold, thin), size (e.g., large, small), and color (e.g., red, blue, green) in real time according to the received event. Furthermore, when rapid changes in tone or pitch are continuously detected, animation effects (e.g., flash, fade-in) can be applied to the telop. Unlike conventional manual editing or simple threshold judgment, these processes involve dynamic change detection and optimization in a high-dimensional feature space using machine learning models, resulting in essential improvements in computer technology such as real-time performance, accuracy, and visual diversity. The technical effect is that changes in the distributor's voice inflection and emotion can be immediately reflected in visual expression, improving viewer immersion and understanding of the distributed content. Specific application fields include live streaming, virtual events, e-sports commentary, remote education, and others.

The voice analysis unit can analyze the intensity and speed of the distributor's voice and determine the display speed and emphasis method of the telop. For example, when the distributor's voice becomes stronger, the intensity is analyzed and the display speed of the telop is increased. When the voice becomes weaker, the intensity is analyzed and the display speed of the telop is decreased. Furthermore, when the speed of the distributor's voice increases, the speed is analyzed and the emphasis method of the telop is changed. By adjusting the display speed and emphasis method of the telop according to the intensity and speed of the distributor's voice, visually effective telops can be provided. Specifically, the voice analysis unit acquires the distributor's audio signal (e.g., PCM data at 16 kHz or higher), performs short-time Fourier transform (STFT) and Mel-frequency cepstral coefficient (MFCC) extraction, and calculates features such as RMS energy (volume), zero-crossing rate, and spectral envelope for each frame. For measuring speech rate, a speech recognition model (e.g., CTC-based speech-to-text conversion) is used to count the number of characters or words per utterance unit and calculate the speech rate per unit time (e.g., characters/second, words/second). The voice analysis unit analyzes these intensity and speed features in a time series and uses convolutional neural networks (CNN) or recurrent neural networks (RNN) to output labels and scores such as “strong”, “weak”, “fast”, “slow” (e.g., 0.0 to 1.0). For example, “loud volume, fast speech rate” results in “strong, fast” labels and high scores, while “quiet volume, slow speech rate” results in “weak, slow” labels and low scores. The voice analysis unit sends these output results to the display unit, which increases the display speed of the telop and changes the font to bold or an emphasis color when “strong”; decreases the display speed and changes the font to thin or pale color when “weak”; accelerates telop animation effects (e.g., slide-in, fade-in) when “fast”; and displays slowly when “slow”. Unlike conventional manual editing or simple rule-based processing, these processes involve dynamic optimization in a high-dimensional feature space using machine learning models, resulting in essential improvements in computer technology such as real-time performance, accuracy, and visual diversity. The technical effect is that the distributor's speech characteristics can be immediately reflected in visual expression, improving viewer immersion and understanding of the distributed content. Specific application fields include live streaming, virtual events, e-sports commentary, remote education, and others.

The voice analysis unit can estimate the distributor's emotion and determine the priority of voice analysis based on the estimated emotion. For example, when the distributor is excited, the emotion is estimated using an emotion engine, and the priority of voice analysis is set high. When the distributor is calm, the emotion is estimated using the emotion engine, and the priority of voice analysis can be set to medium. Furthermore, when the distributor is nervous, the emotion is estimated using the emotion engine, and the priority of voice analysis can be set low. By determining the priority of voice analysis based on the distributor's emotion, important analyses can be performed preferentially. Specifically, the voice analysis unit acquires the distributor's voice signal (e.g., PCM data at 16 kHz or higher), performs preprocessing such as short-time Fourier transform (STFT) and Mel-frequency cepstral coefficient (MFCC) extraction, and inputs the data into a voice emotion recognition model (e.g., CNN, BiLSTM, Transformer-based). Examples of input include voices with “high pitch, loud volume, fast speech rate” and voices with “low pitch, soft volume, slow speech rate”; outputs include emotion labels such as “excited,” “calm,” “nervous” (one-hot vectors or probability distributions), and emotion intensity scores (0.0 to 1.0). Based on these output values, the voice analysis unit dynamically changes the priority of each processing module in the voice analysis pipeline (e.g., noise reduction, feature extraction, speech recognition, emotion enhancement processing). For example, in the “excited” state, emotion enhancement processing and high-precision speech recognition are prioritized; in the “calm” state, standard speech recognition is prioritized; and in the “nervous” state, noise reduction and spectral enhancement processing are prioritized. As subsequent processing, priority control optimizes resource allocation and real-time performance of the entire system, preventing the oversight of important information and improving analysis accuracy. Unlike conventional static pipelines or manual settings by humans, these processes involve dynamic optimization by machine learning models, resulting in essential improvements in computer technology such as real-time performance, analysis accuracy, and overall system efficiency. As a technical effect, optimal voice analysis processing can be preferentially executed according to the distributor's emotional state, thereby preventing the oversight of important information and improving analysis accuracy. Specific application fields include live streaming, virtual events, e-sports commentary, and remote education.

The voice analysis unit can analyze background noise in the distributor's voice and correct the analysis result according to the noise level. For example, when the background noise in the distributor's voice is high, the noise level is analyzed and noise reduction is applied to correct the analysis result. When the background noise in the distributor's voice is low, the noise level is analyzed and noise reduction can be minimized to correct the analysis result. Furthermore, when the background noise in the distributor's voice fluctuates, the noise level can be analyzed in real time and dynamic noise reduction can be applied to correct the analysis result. By correcting the analysis result according to the background noise in the distributor's voice, more accurate analysis results can be obtained. Specifically, the voice analysis unit acquires the distributor's voice signal (e.g., PCM data at 16 kHz or higher), performs short-time Fourier transform (STFT) and Mel-frequency cepstral coefficient (MFCC) extraction, and calculates features such as spectral envelope, noise floor, SNR (signal-to-noise ratio), and zero-crossing rate for each frame. The voice analysis unit inputs these feature vectors (e.g., 128 dimensions) into a convolutional neural network (CNN) or recurrent neural network (RNN) to estimate the type of background noise (e.g., environmental sound, noise, sudden sound) and noise level (e.g., continuous value from 0.0 to 1.0). For example, when “air conditioner noise is loud,” the label is “environmental sound” and the noise level is 0.8; in a “quiet room,” the label is “silent” and the noise level is 0.1. The voice analysis unit dynamically adjusts the parameters of noise reduction processing (e.g., spectral subtraction, Wiener filter, band-pass filter) according to the estimated noise level and corrects the analysis result (e.g., speech recognition result, emotion estimation result). When the noise is high, strong noise reduction is applied; when the noise is low, minimal processing is performed. When the noise level fluctuates, dynamic noise reduction is applied for each frame. As subsequent processing, the noise-corrected voice data is input to downstream modules such as speech recognition, emotion estimation, and telop generation, thereby improving overall analysis accuracy. Unlike conventional static filter settings or manual correction by humans, these processes involve dynamic optimization in high-dimensional feature space by machine learning models, resulting in essential improvements in computer technology such as improved voice analysis accuracy, reduced misrecognition rate, and ensured real-time performance. As a technical effect, high-precision voice analysis independent of the distribution environment becomes possible, and the reliability of telop generation and utterance recognition is improved. Specific application fields include live streaming, virtual events, e-sports commentary, and remote education.

The following is a brief description of the processing flow of Example of the Embodiment. Specifically, the present system operates in cooperation with multiple hardware and software modules, such as a voice analysis unit, a record reference unit, a display unit, and a speech display unit. The voice analysis unit acquires the distributor's voice signal (e.g., PCM data at 16 kHz or higher), performs preprocessing such as short-time Fourier transform (STFT) and Mel-frequency cepstral coefficient (MFCC) extraction, and generates feature vectors (e.g., 128 dimensions) such as tone, pitch, and intensity of the voice. These features are input into a convolutional neural network (CNN), a bidirectional long short-term memory network (BiLSTM), or a Transformer-based voice emotion recognition model, and outputs such as emotion labels (e.g., excited, calm, nervous as one-hot vectors) and emotion intensity scores (0.0 to 1.0) are obtained. The record reference unit acquires past distribution records (e.g., audio transcripts of video files, text chat logs, metadata) from a database and performs frequency analysis of utterance content, key phrase extraction, and style clustering using a natural language processing model (e.g., Transformer-based contextual embedding model). The display unit receives font information (e.g., Gothic, Mincho), size (e.g., 24 pt, 36 pt), color (e.g., red, blue, green), and decoration (e.g., bold, italic, underline) parameters from the record reference unit and renders the telop in real time on a 2D/3D graphics engine using a GPU. The speech display unit acquires the user's speech or text input in real time, analyzes the content of the utterance using a speech recognition model (e.g., CTC-based speech-to-text conversion) and a natural language understanding model, and arranges it as a 3D object in a VR space as a comic speech balloon or chat bubble. Unlike conventional manual editing or simple rule-based processing by humans, these series of processes involve dynamic judgment and optimization by machine learning models in high-dimensional feature space, resulting in essential improvements in computer technology such as faster processing speed, improved telop generation accuracy, and both visual consistency and diversity. As a technical effect, telop generation reflecting the distributor's emotion and past distribution trends improves viewer immersion and understanding, and dramatically enhances the communication experience in VR space. Specific application fields include live streaming distribution, virtual events, e-sports commentary, remote education, virtual conferences, and other diverse use cases requiring real-time performance and visual interaction.

Step 1: The voice analysis unit analyzes the tone of the distributor's voice. The tone of the distributor's voice includes the tone, pitch, and intensity of the voice. For example, the tone of the distributor's voice is analyzed, and if the distributor is excited, the telop is displayed in bold or with a large font. In addition, the pitch of the distributor's voice is analyzed, and if the distributor is calm, the telop can be displayed in a standard font. Step 2: The record reference unit analyzes past distribution records and determines the font and style of the telop based on the content or style of the distributor's utterance. Past distribution records include recorded data and text logs. For example, if a specific phrase has been frequently used in the past, a specific font style is applied to that phrase. In addition, the content of the distributor's utterance is analyzed from past distribution records, and the style of the telop can be determined based on the content. Step 3: The display unit displays the telop based on the font or style determined by the record reference unit. For example, the telop is displayed using the font determined by the record reference unit. In addition, the telop can be displayed based on the style determined by the record reference unit. Step 4: The speech display unit analyzes the user's utterance in real time and displays the content of the utterance in a comic speech balloon format. For example, when the user utters “Hello,” the utterance is displayed in the form of a speech balloon. In addition, the shape and size of the speech balloon can be changed according to the content of the user's utterance. Specifically, the voice analysis unit acquires the distributor's voice signal (e.g., PCM data at 16 kHz or higher), performs preprocessing such as short-time Fourier transform (STFT) and Mel-frequency cepstral coefficient (MFCC) extraction, and generates feature vectors (e.g., 128 dimensions) such as tone, pitch, and intensity of the voice. These features are input into a convolutional neural network (CNN), a bidirectional long short-term memory network (BiLSTM), or a Transformer-based voice emotion recognition model, and outputs such as emotion labels (e.g., excited, calm, nervous as one-hot vectors) and emotion intensity scores (0.0 to 1.0) are obtained. The record reference unit acquires past distribution records (e.g., audio transcripts of video files, text chat logs, metadata) from a database and performs frequency analysis of utterance content, key phrase extraction, and style clustering using a natural language processing model (e.g., Transformer-based contextual embedding model). The display unit receives font information (e.g., Gothic, Mincho), size (e.g., 24 pt, 36 pt), color (e.g., red, blue, green), and decoration (e.g., bold, italic, underline) parameters from the record reference unit and renders the telop in real time on a 2D/3D graphics engine using a GPU. The speech display unit acquires the user's speech or text input in real time, analyzes the content of the utterance using a speech recognition model (e.g., CTC-based speech-to-text conversion) and a natural language understanding model, and arranges it as a 3D object in a VR space as a comic speech balloon or chat bubble. Unlike conventional manual editing or simple rule-based processing by humans, these series of processes involve dynamic judgment and optimization by machine learning models in high-dimensional feature space, resulting in essential improvements in computer technology such as faster processing speed, improved telop generation accuracy, and both visual consistency and diversity. As a technical effect, telop generation reflecting the distributor's emotion and past distribution trends improves viewer immersion and understanding, and dramatically enhances the communication experience in VR space. Specific application fields include live streaming distribution, virtual events, e-sports commentary, remote education, virtual conferences, and other diverse use cases requiring real-time performance and visual interaction.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the voice analysis unit, the record reference unit, the display unit, and the speech display unit, is implemented by at least one of, for example, the smart device 14 and the data processing apparatus 12. For example, the voice analysis unit is implemented by a processor 46 of the smart device 14 and analyzes the tone of the distributor's voice. The record reference unit is implemented, for example, by a specific processing unit 290 of the data processing apparatus 12 and analyzes past distribution records. The display unit is implemented, for example, by a display 40A of the smart device 14 and displays the telop. The speech display unit is implemented, for example, by a control unit 46A of the smart device 14 and displays the user's utterance in a speech balloon format, similar to a comic. The correspondence between each unit and the device or control unit is not limited to the examples described above and various modifications are possible.

### Second Embodiment

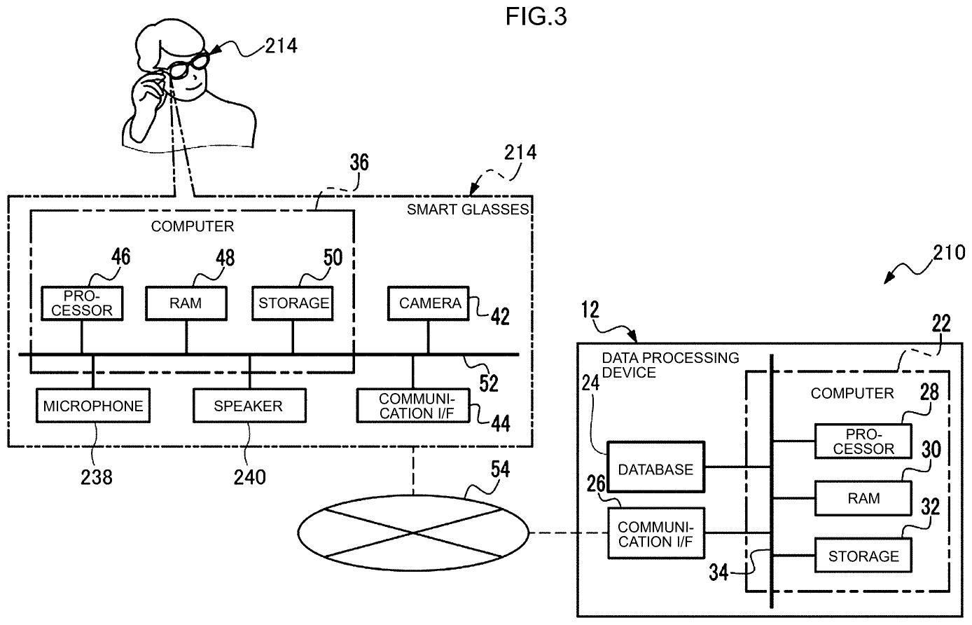

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

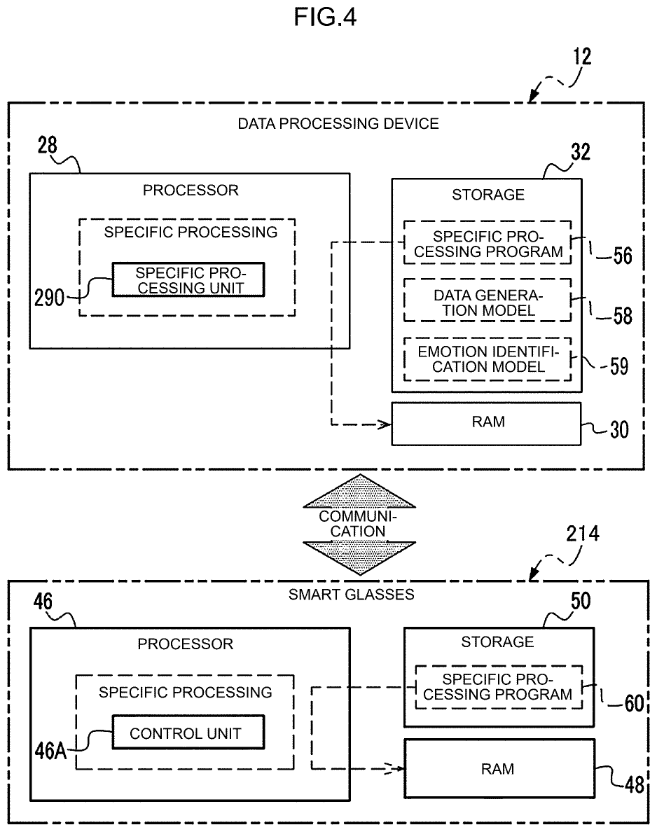

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the voice analysis unit, the record reference unit, the display unit, and the speech display unit, is implemented by at least one of, for example, the smart glasses 214 and the data processing apparatus 12. For example, the voice analysis unit is implemented by a processor 46 of the smart glasses 214 and analyzes the tone of the distributor's voice. The record reference unit is implemented, for example, by a specific processing unit 290 of the data processing apparatus 12 and analyzes past distribution records. The display unit is implemented, for example, by a display of the smart glasses 214 and displays the telop. The speech display unit is implemented, for example, by a control unit 46A of the smart glasses 214 and displays the user's utterance in a speech balloon format, similar to a comic. The correspondence between each unit and the device or control unit is not limited to the examples described above and various modifications are possible.

### Third Embodiment

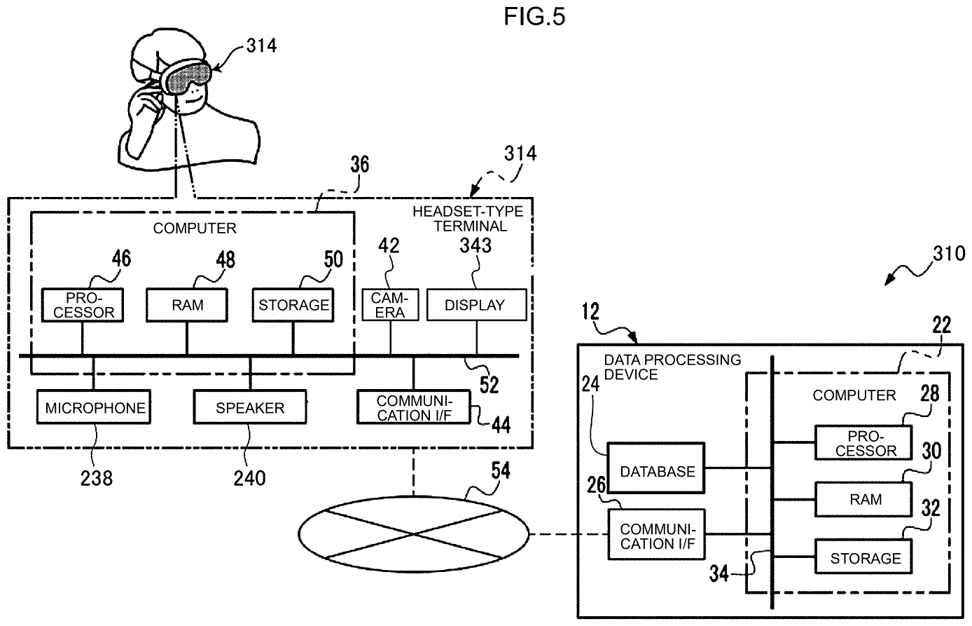

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

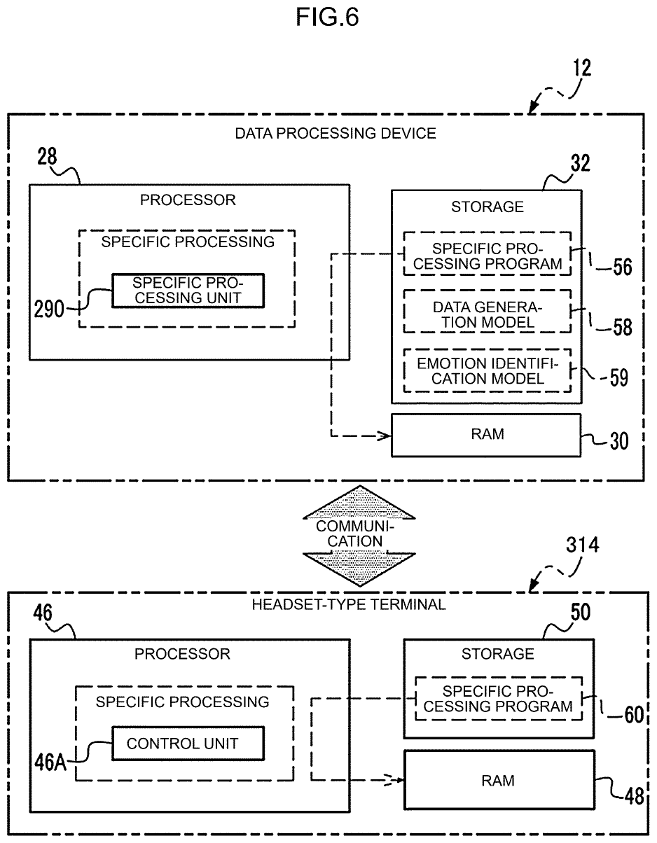

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the voice analysis unit, the record reference unit, the display unit, and the speech display unit, is implemented by at least one of, for example, the headset-type terminal 314 and the data processing apparatus 12. For example, the voice analysis unit is implemented by a processor 46 of the headset-type terminal 314 and analyzes the tone of the distributor's voice. The record reference unit is implemented, for example, by a specific processing unit 290 of the data processing apparatus 12 and analyzes past distribution records. The display unit is implemented, for example, by a display 343 of the headset-type terminal 314 and displays the telop. The speech display unit is implemented, for example, by a control unit 46A of the headset-type terminal 314 and displays the user's utterance in a speech balloon format, similar to a comic. The correspondence between each unit and the device or control unit is not limited to the examples described above and various modifications are possible.

### Fourth Embodiment

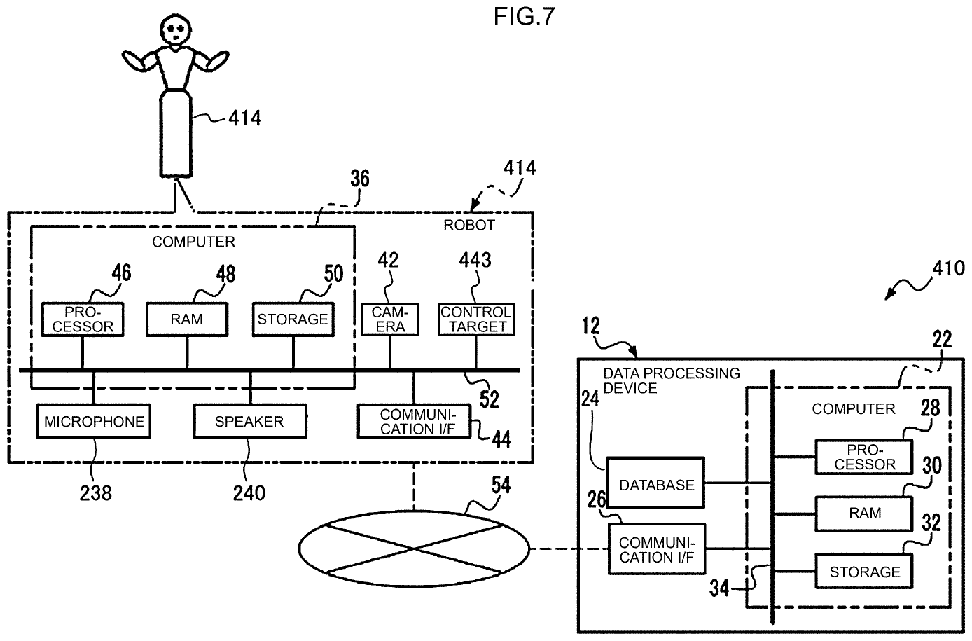

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

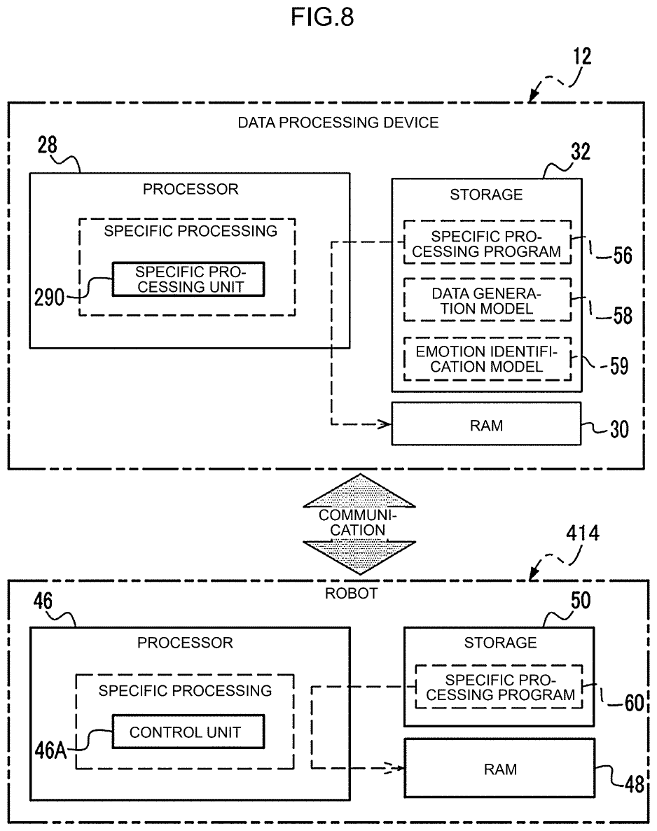

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the voice analysis unit, the record reference unit, the display unit, and the speech display unit, is implemented by at least one of, for example, the robot 414 and the data processing apparatus 12. For example, the voice analysis unit is implemented by a processor 46 of the robot 414 and analyzes the tone of the distributor's voice. The record reference unit is implemented, for example, by a specific processing unit 290 of the data processing apparatus 12 and analyzes past distribution records. The display unit is implemented, for example, by a display of the robot 414 and displays the telop. The speech display unit is implemented, for example, by a control unit 46A of the robot 414 and displays the user's utterance in a speech balloon format, similar to a comic. The correspondence between each unit and the device or control unit is not limited to the examples described above and various modifications are possible.

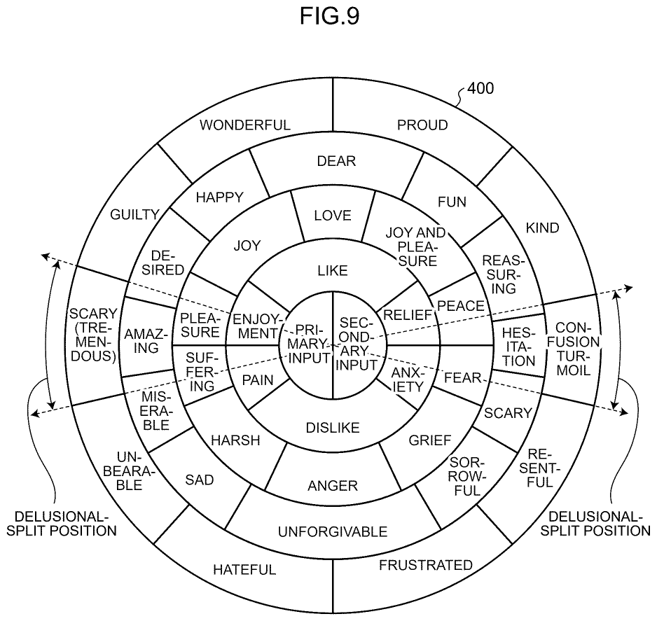

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

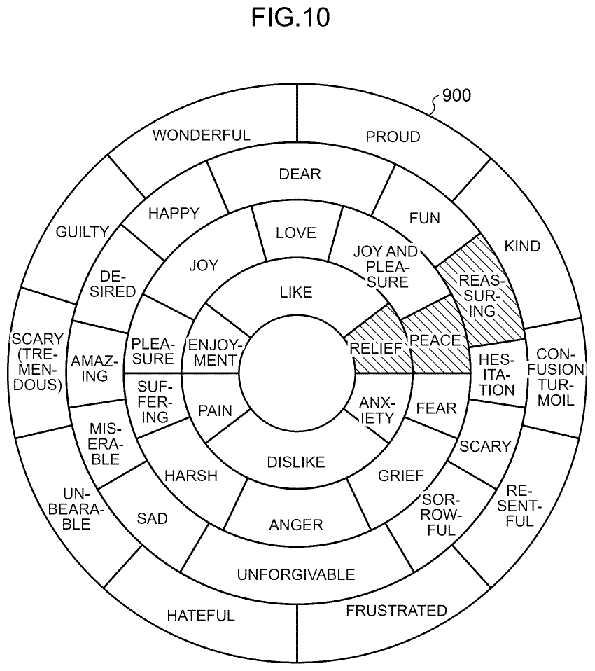

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a voice analysis unit configured to analyze the tone of a distributor's voice; a record reference unit configured to determine a font or style of a telop based on the tone analyzed by the voice analysis unit; a display unit configured to display the telop based on the font or style determined by the record reference unit; and a speech display unit configured to analyze a user's utterance in real time and display it in a speech balloon format.
(Supplementary Note 2)The system according to Supplementary Note 1, wherein the voice analysis unit is configured to analyze the tone of the distributor's voice in real time.
(Supplementary Note 3)The system according to Supplementary Note 1, wherein the record reference unit is configured to analyze past distribution records and determine the font or style of the telop based on the content or style of the distributor's utterance.
(Supplementary Note 4)The system according to Supplementary Note 1, wherein the display unit is configured to display the telop based on the font or style determined by the record reference unit.
(Supplementary Note 5)The system according to Supplementary Note 1, wherein the speech display unit is configured to analyze a user's utterance in real time and display the content of the utterance in a speech balloon format.
(Supplementary Note 6)The system according to Supplementary Note 1, wherein the voice analysis unit is configured to estimate the distributor's emotion and adjust the accuracy of voice analysis based on the estimated emotion.
(Supplementary Note 7)The system according to Supplementary Note 1, wherein the voice analysis unit is configured to detect changes in the tone and pitch of the distributor's voice in real time and reflect the detection in the analysis result.
(Supplementary Note 8)The system according to Supplementary Note 1, wherein the voice analysis unit is configured to analyze the intensity and speed of the distributor's voice and determine the display speed and emphasis method of the telop.
(Supplementary Note 9)The system according to Supplementary Note 1, wherein the voice analysis unit is configured to estimate the distributor's emotion and determine the priority of voice analysis based on the estimated emotion.
(Supplementary Note 10)The system according to Supplementary Note 1, wherein the voice analysis unit is configured to analyze background noise in the distributor's voice and correct the analysis result according to the noise level.
(Supplementary Note 11)The system according to Supplementary Note 1, wherein the voice analysis unit is configured to analyze characteristics of the distributor's voice and apply a telop style corresponding to a specific voice quality.
(Supplementary Note 12)The system according to Supplementary Note 1, wherein the record reference unit is configured to estimate the distributor's emotion and adjust the method of referring to past distribution records based on the estimated emotion.
(Supplementary Note 13)The system according to Supplementary Note 1, wherein the record reference unit is configured to extract specific keywords or phrases from past distribution records and determine the style of the telop according to their frequency.
(Supplementary Note 14)The system according to Supplementary Note 1, wherein the record reference unit is configured to analyze portions of past distribution records that received particularly positive viewer reactions and preferentially apply their style.
(Supplementary Note 15)The system according to Supplementary Note 1, wherein the record reference unit is configured to estimate the distributor's emotion and adjust the frequency of referring to past distribution records based on the estimated emotion.
(Supplementary Note 16)The system according to Supplementary Note 1, wherein the record reference unit is configured to preferentially refer to portions of past distribution records related to specific events or topics.
(Supplementary Note 17)The system according to Supplementary Note 1, wherein the record reference unit is configured to analyze viewer comments in past distribution records and determine the style of the telop based on the content of the comments.
(Supplementary Note 18)The system according to Supplementary Note 1, wherein the display unit is configured to estimate the distributor's emotion and adjust the display method of the telop based on the estimated emotion.
(Supplementary Note 19)The system according to Supplementary Note 1, wherein the display unit is configured to dynamically change the display position of the telop and guide the viewer's gaze.
(Supplementary Note 20)The system according to Supplementary Note 1, wherein the display unit is configured to adjust the display time of the telop and determine the optimal display timing according to the distribution content.
(Supplementary Note 21)The system according to Supplementary Note 1, wherein the display unit is configured to estimate the distributor's emotion and adjust the display order of the telop based on the estimated emotion.
(Supplementary Note 22)The system according to Supplementary Note 1, wherein the display unit is configured to change the display color of the telop according to the distribution content or viewer preferences.
(Supplementary Note 23)The system according to Supplementary Note 1, wherein the display unit is configured to optimize the display font of the telop for the viewer's device.
(Supplementary Note 24)The system according to Supplementary Note 1, wherein the speech display unit is configured to estimate the user's emotion and adjust the display method of the speech balloon based on the estimated emotion.
(Supplementary Note 25)The system according to Supplementary Note 1, wherein the speech display unit is configured to dynamically change the shape or size of the speech balloon according to the content of the user's utterance.
(Supplementary Note 26)The system according to Supplementary Note 1, wherein the speech display unit is configured to analyze emphasized portions of the user's utterance and perform emphasis display within the speech balloon.
(Supplementary Note 27)The system according to Supplementary Note 1, wherein the speech display unit is configured to estimate the user's emotion and adjust the display order of the speech balloon based on the estimated emotion.
(Supplementary Note 28)The system according to Supplementary Note 1, wherein the speech display unit is configured to change the background color or border of the speech balloon according to the content of the user's utterance.
(Supplementary Note 29)The system according to Supplementary Note 1, wherein the speech display unit is configured to analyze the context of the user's utterance and display related icons or emojis within the speech balloon.

What is claimed is:

1. A system comprising:
a communication interface configured to communicate with a client terminal via a packet-switched network;
a processor;
a random-access memory;
a memory storing a data generation model obtained by deep learning on a neural network, and an emotion identification model;
a database; and
circuitry configured to:
receive, from the client terminal via the communication interface, audio data representing a voice of a distributor captured by a microphone of the client terminal;
analyze the audio data using the emotion identification model to generate an emotion label for the distributor;
determine a font or style of a telop based on the emotion label;
analyze past distribution records stored in the database to determine a style modification for the telop based on the past distribution records;
transmit telop rendering data to the client terminal via the communication interface and the packet-switched network, the telop rendering data causing the client terminal to display the telop;
receive, from the client terminal via the communication interface, utterance data of a user; and
generate speech balloon display data based on the utterance data and transmit the speech balloon display data to the client terminal via the communication interface.

2. The system according to claim 1, wherein the circuitry is configured to extract the feature vectors from the audio data by performing at least one of a short-time Fourier transform or a mel-frequency cepstral coefficient extraction, and to input the feature vectors into a voice emotion recognition model comprising at least one of a convolutional neural network, a bidirectional long short-term memory network, or a Transformer-based model to generate the emotion label and an emotion intensity score.

3. The system according to claim 2, wherein the feature vectors comprise at least one of a tone feature representing an average frequency and a formant distribution, a pitch feature representing a fundamental frequency, or an intensity feature representing a root-mean-square energy, and wherein the feature vectors have 128 or more dimensions.

4. The system according to claim 1, wherein the circuitry is further configured to detect a change in at least one of a tone or a pitch of the voice of the distributor in real time using at least one of an autoregressive model, a recurrent neural network, or a Transformer model with a self-attention mechanism, and to dynamically change the font or style of the telop based on the detected change.

5. The system according to claim 1, wherein the circuitry is further configured to analyze an intensity and a speed of the voice of the distributor, and to determine a display speed and an emphasis method of the telop based on the analyzed intensity and speed.

6. The system according to claim 1, wherein the circuitry is further configured to estimate the emotion of the distributor and to determine a priority of voice analysis processing based on the estimated emotion, such that when the estimated emotion indicates excitement, emotion enhancement processing and high-precision speech recognition are prioritized, and when the estimated emotion indicates nervousness, noise reduction and spectral enhancement processing are prioritized.

7. The system according to claim 1, wherein the circuitry is further configured to analyze background noise in the audio data and to dynamically adjust parameters of noise reduction processing based on an estimated noise level, such that when the noise level is high, strong noise reduction is applied, and when the noise level is low, minimal noise reduction is applied.

8. The system according to claim 1, wherein the circuitry is further configured to analyze characteristics of the voice of the distributor to determine a voice quality label, and to apply a telop color corresponding to the voice quality label, such that a bright color is applied for a high-pitched voice quality and a dark color is applied for a low-pitched voice quality.

9. The system according to claim 1, wherein the circuitry is configured to analyze the past distribution records by performing frequency analysis of utterance content, key phrase extraction, and style clustering using a natural language processing model comprising a Transformer-based contextual embedding model, and to assign a font, a color, or a decoration to extracted key phrases based on a frequency score of each key phrase.

10. The system according to claim 1, wherein the circuitry is further configured to analyze portions of the past distribution records that received positive viewer reactions by aggregating at least one of viewer comment counts, reaction counts, or playback counts in a time series, and to preferentially apply a style of the portions with positive viewer reactions to the telop.

11. The system according to claim 1, wherein the circuitry is further configured to estimate the emotion of the distributor and to adjust a frequency of analyzing the past distribution records based on the estimated emotion, such that when the estimated emotion indicates excitement, the past distribution records are analyzed at a higher frequency, and when the estimated emotion indicates calmness, the past distribution records are analyzed at a lower frequency.

12. The system according to claim 1, wherein the circuitry is further configured to preferentially analyze portions of the past distribution records related to a specific event or topic by assigning relevance scores using a topic classification model, and to apply a style associated with the specific event or topic to the telop.

13. The system according to claim 1, wherein the circuitry is further configured to analyze viewer comments in the past distribution records using a sentiment analysis model to estimate a sentiment polarity and a sentiment intensity score for each comment, and to adjust a color of the telop based on the estimated sentiment polarity.

14. The system according to claim 1, wherein the circuitry is further configured to estimate the emotion of the distributor and to adjust a display method of the telop based on the estimated emotion, such that when the estimated emotion indicates excitement, a font size is increased and an animation effect is added, and when the estimated emotion indicates nervousness, a subdued color and a static display are used.

15. The system according to claim 1, wherein the circuitry is further configured to dynamically change a display position of the telop based on gaze data received from the client terminal via the communication interface, the gaze data comprising coordinates of a gaze point on a screen of the client terminal.

16. The system according to claim 1, wherein the circuitry is further configured to generate the speech balloon display data by converting the utterance data into text using a speech recognition model, analyzing a context and an emotion of the utterance using a natural language understanding model, and determining a shape, a size, and a color of the speech balloon based on an analysis result, such that a rectangular shape is used for long utterances, a circular shape is used for short utterances, and an angular shape is used for questions.

17. The system according to claim 1, wherein the circuitry is further configured to optimize a display font of the telop based on device information of the client terminal received via the communication interface, the device information comprising at least one of a screen resolution, a screen size, or a device type.

18. A system comprising:
a communication interface configured to communicate, via a packet-switched network conforming to at least one of a 5G, Wi-Fi, or Bluetooth communication standard, with a client terminal comprising a microphone, a speaker, a camera having a CMOS image sensor, and a display;
a processor;
a random-access memory;
a memory storing a data generation model obtained by deep learning on a neural network, and an emotion identification model;
a database storing past distribution records; and
circuitry configured to:
receive, from the client terminal via the communication interface, audio data representing a voice of a distributor captured by the microphone;
extract feature vectors from the audio data by performing at least one of a short-time Fourier transform or a mel-frequency cepstral coefficient extraction, and input the feature vectors into a voice emotion recognition model comprising at least one of a convolutional neural network, a bidirectional long short-term memory network, or a Transformer-based model to generate an emotion label and an emotion intensity score;
determine a font or style of a telop based on the emotion label and the emotion intensity score;
analyze the past distribution records stored in the database using a natural language processing model comprising a Transformer-based contextual embedding model to extract key phrases, and determine a style modification for the telop based on a frequency of the extracted key phrases;
transmit telop rendering data to the client terminal via the communication interface, the telop rendering data causing the client terminal to display the telop via the display;
receive, from the client terminal via the communication interface, utterance data of a user captured by the microphone; and
generate speech balloon display data by converting the utterance data into text using a speech recognition model and determining a shape and a size of a speech balloon based on the text, and transmit the speech balloon display data to the client terminal via the communication interface, the speech balloon display data causing the client terminal to render the speech balloon via the display.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a memory storing a data generation model obtained by deep learning on a neural network and an emotion identification model, a database, and a communication interface, the method comprising:
receiving, from a client terminal via the communication interface and a packet-switched network, audio data representing a voice of a distributor captured by a microphone of the client terminal;
analyzing the audio data using the emotion identification model to generate an emotion label for the distributor;
determining a font or style of a telop based on the emotion label;
analyzing past distribution records stored in the database to determine a style modification for the telop based on the past distribution records;
transmitting telop rendering data to the client terminal via the communication interface and the packet-switched network, the telop rendering data causing the client terminal to display the telop;
receiving, from the client terminal via the communication interface, utterance data of a user; and
generating speech balloon display data based on the utterance data and transmitting the speech balloon display data to the client terminal via the communication interface.
